(19) United States
(12) Patent Application Publication
(10) Pub. No.: US 2023/0236854 A1
(43) Pub. Date: Jul. 27, 2023

(54) USER INTERFACE FOR DELIVERED VIRTUAL DESKTOP

(71) Applicant: Citrix Systems, Inc., Fort Lauderdale, FL (US)

(72) Inventors: Jian Luo, Nanjing (CN); Cheng Zhang, Nanjing (CN); Hailong Li, Nanjing (CN); Xiao Zhang, Nanjing (CN)

(21) Appl. No.: 17/672,918

(22) Filed: Feb. 16, 2022

Related U.S. Application Data
(63) Continuation of application No. PCT/CN2022/073897, filed on Jan. 26, 2022.

(51) Int. Cl. G06F 9/451; G06F 3/0488

(52) U.S. Cl. CPC G06F 9/452; G06F 3/0488

(57) ABSTRACT

A client device may receive, from a remote computing system via a first communications channel, first graphics content for a virtual desktop of a computing environment hosted on the remote computing system and delivered to the client device. The first graphics content may be sent from the client device to at least one external. The client device may receive, from the remote computing system via a second communications channel, data indicative of at least one characteristic of plurality of resources hosted in the computing environment and accessible via the virtual desktop. While the virtual desktop is presented on the at least one external monitor and based at least in part on the received data, second graphics content indicative of the at least one characteristic of the plurality of resources may be presented on a touchscreen of the client device.

### CROSS-REFERENCE TO RELATED APPLICATIONS

This application is a continuation of and claims the benefit under 35 U.S.C. § 120 and 35 U.S.C. § 365(c) to International Application PCT/CN2022/073897, entitled IMPROVED USER INTERFACE FOR DELIVERED VIRTUAL DESKTOP, with an international filing date of Jan. 26, 2022, the entire contents of which are incorporated herein by reference for all purposes.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a client device and from a remote computing system via a first communications channel, first graphics content for a virtual desktop of a computing environment hosted on the remote computing system and delivered to the client device; sending, from the client device to at least one external monitor, the first graphics content such that at least a portion of the virtual desktop is presented on the at least one external monitor; receiving, by the client device and from the remote computing system via a second communications channel that is different than the first communications channel, first data indicative of at least one characteristic of plurality of resources hosted in the computing environment and accessible via the virtual desktop; and while the virtual desktop is presented on the at least one external monitor, presenting, on a touchscreen of the client device and based at least in part on the first data, second graphics content indicative of the at least one characteristic of the plurality of resources.

In some disclosed embodiments, a system includes at least one processor, and at least one computer-readable medium encoded with instructions which, when executed by the at least one processor, cause the system to receive, by a client device and from a remote computing system via a first communications channel, first graphics content for a virtual desktop of a computing environment hosted on the remote computing system and delivered to the client device, to send, from the client device to at least one external monitor, the first graphics content such that at least a portion of the virtual desktop is presented on the at least one external monitor, to receive, by the client device and from the remote computing system via a second communications channel that is different than the first communications channel, first data indicative of at least one characteristic of plurality of resources hosted in the computing environment and accessible via the virtual desktop, and while the virtual desktop is presented on the at least one external monitor, to present, on a touchscreen of the client device and based at least in part on the first data, second graphics content indicative of the at least one characteristic of the plurality of resources.

In some disclosed embodiments, at least one non-transitory computer-readable medium is encoded with instructions which, when executed by the at least one processor included in a system, cause the system to receive, by a client device and from a remote computing system via a first communications channel, first graphics content for a virtual desktop of a computing environment hosted on the remote computing system and delivered to the client device, to send, from the client device to at least one external monitor, the first graphics content such that at least a portion of the virtual desktop is presented on the at least one external monitor, to receive, by the client device and from the remote computing system via a second communications channel that is different than the first communications channel, first data indicative of at least one characteristic of plurality of resources hosted in the computing environment and accessible via the virtual desktop, and while the virtual desktop is presented on the at least one external monitor, to present, on a touchscreen of the client device and based at least in part on the first data, second graphics content indicative of the at least one characteristic of the plurality of resources.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system for providing an improved user interface for a delivered virtual desktop;

FIG. 1B shows a first example of additional user interface (UI) content that can be provided on a display in accordance with some embodiments of the present disclosure;

FIG. 1C shows a second example of additional UI content that can be provided on a display in accordance with some embodiments of the present disclosure;

FIG. 1D shows a third example of additional UI content that can be provided on a display in accordance with some embodiments of the present disclosure;

FIG. 2 is a diagram of a network environment in which some embodiments of the system for providing an improved user interface for a delivered virtual desktop disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram illustrating key components of a resource delivery system which may be useful for practicing embodiments described herein;

FIG. 5B illustrates an example deployment of a resource delivery system such as that shown in FIG. 5A;

FIG. 5C illustrates an example process for handling user connections within the deployment shown in FIG. 5B;

FIG. 5D shows examples of paths through which the resource manager and the resource monitor shown in FIG. 5B may access stored data;

FIG. 5E illustrates a simple layout of a resource delivery system in which tag restrictions may be used to limit which machines will be considered for certain desktop and application launches;

FIG. 5F is a block diagram of a resource delivery system similar to the shown in FIG. 5A but in which several elements are provided as a service within a cloud-based computing environment;

FIG. 6 depicts an illustrative virtualized (hypervisor) system architecture that may be used in accordance with one or more illustrative aspects described herein;

FIG. 7 shows additional details of the mobile device and the remote computing system shown in FIG. 1;

FIG. 8 is a sequence diagram illustrating messages that may be communicated amongst various components in connection with a first example implementation of the system shown in FIG. 7;

FIG. 9 shows an example routine that may be employed by a component of the resource access application shown in FIG. 7 in accordance with the implementation described in connection with the sequence diagram shown in FIG. 8;

FIG. 10A shows a first example routine that may be employed by a component of the resource delivery agent shown in FIG. 7 in accordance with the implementation described in connection with the sequence diagram shown in FIG. 8;

FIG. 10B shows a second example routine that may be employed by a component of the resource delivery agent shown in FIG. 7 in accordance with the implementation described in connection with the sequence diagram shown in FIG. 8;

FIG. 11 is a sequence diagram illustrating messages that may be communicated amongst various components in connection with a second example implementation of the system shown in FIG. 7;

FIG. 12 shows an example routine that may be employed by a component of the resource access application shown in FIG. 7 in accordance with the implementation described in connection with the sequence diagram shown in FIG. 11; and

FIG. 13 shows an example routine that may be employed by a component of the resource delivery agent shown in FIG. 7 in accordance with the implementation described in connection with the sequence diagram shown in FIG. 11.

### DETAILED DESCRIPTION

For purposes of reading the description of the various embodiments below, the following descriptions of the sections of the specification and their respective contents may be helpful:

Section A provides an introduction to example embodiments of a system for providing an improved user interface for a delivered virtual desktop;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes an example implementation of a resource delivery system which may be useful for practicing embodiments described herein;

Section F describes an example architecture of a resource virtualization server;

Section G provides a more detailed description of example embodiments of the system for providing an improved user interface for a delivered virtual desktop that are introduced in Section A;

Section H describes example implementations of methods, systems/devices, and computer-readable media in accordance with the present disclosure.

### A. Introduction to Illustrative Embodiments of a System for Providing an Improved User Interface for a Delivered Virtual Desktop

Hardware capabilities of mobile devices, such as smartphones and tablets, have improved to the point where it is feasible to seamlessly deliver a virtual desktop of a remote computing system to such devices. Such capabilities are currently provided, for example, by the Citrix Workspace app for iOS. An external monitor may also be connected to a mobile device to permit such a delivered virtual desktop to be mirrored with or extended onto the external monitor. One or more external user interface devices, e.g., a keyboard, a mouse, a trackpad, etc., may additionally be connected to the mobile device to facilitate user interaction with the displayed virtual desktop.

The inventors have recognized and appreciated that simply mirroring or extending the delivered virtual desktop to an external monitor of a mobile device, while providing some significant benefits, does not take full advantage of the smaller, built-in touchscreen of the mobile device. In particular, the inventors have identified a number of challenges faced by users when interacting with a virtual desktop, and have devised of a number of beneficial uses for the touchscreen of a mobile device that, if employed in parallel with the presentation of a virtual desktop on one or more external monitors, can markedly improve the user's experience interacting with the virtual desktop.

One challenge the inventors identified is that, even where the virtual desktop is displayed on a larger, external monitor, it can be difficult and/or cumbersome for a user to locate particular files and/or applications the user wants to access or launch. To access a specific application, a user will typically need to click on or otherwise select the “start” menu and search through a long list of available applications, or else hunt through a collection of shortcut icons on the desktop. Likewise, to locate a particular file, a user will typically need to visually scan through file icons on the virtual desktop, or navigate amongst various folders accessible via the virtual desktop, to track down the desired file. These processes can be made even more difficult when a user's virtual desktop is cluttered or poorly organized.

Another challenge the inventors identified is that it can be difficult and/or cumbersome to keep track of notifications from applications that are running within the remote computing environment that is hosting the delivered virtual desktop. It is common for a user to have a large number of application windows open simultaneously within a virtual desktop, but for the user's attention to be focused on just one window at a time. In such circumstances, it is not uncommon for users to miss or ignore at least some notifications from running applications. While it may be possible for the user to open a separate notification management window (e.g., by selecting a particular task bar icon) to view previously sent notifications, it can be difficult and/or cumbersome for users to navigate to and/or interact with such a notification management window. For this reason, it is not uncommon for unread application notifications to “stack up” via a hidden, background process, with the issues that prompted such notifications not being addressed, and/or with the notifications never being viewed.

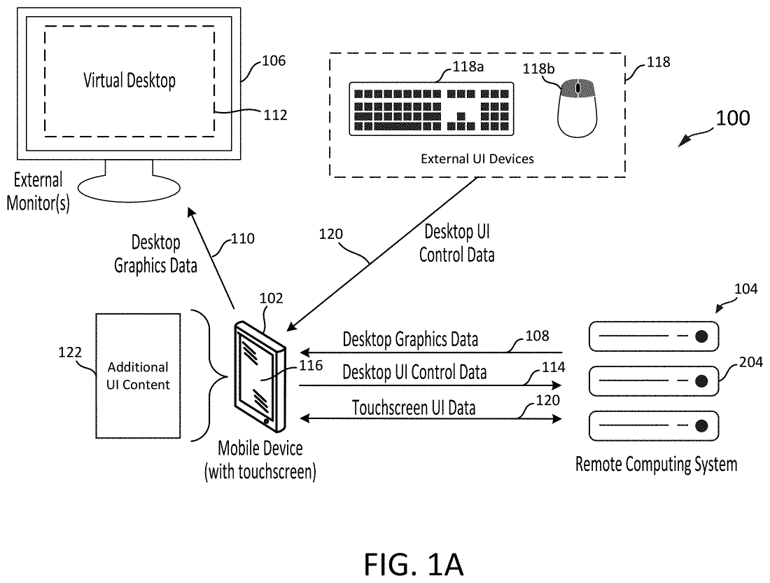

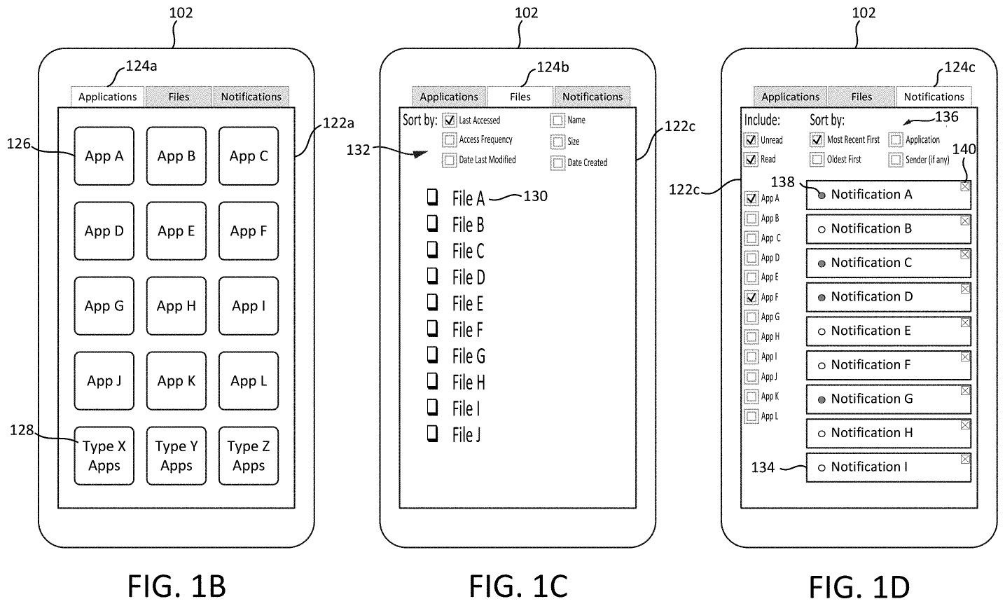

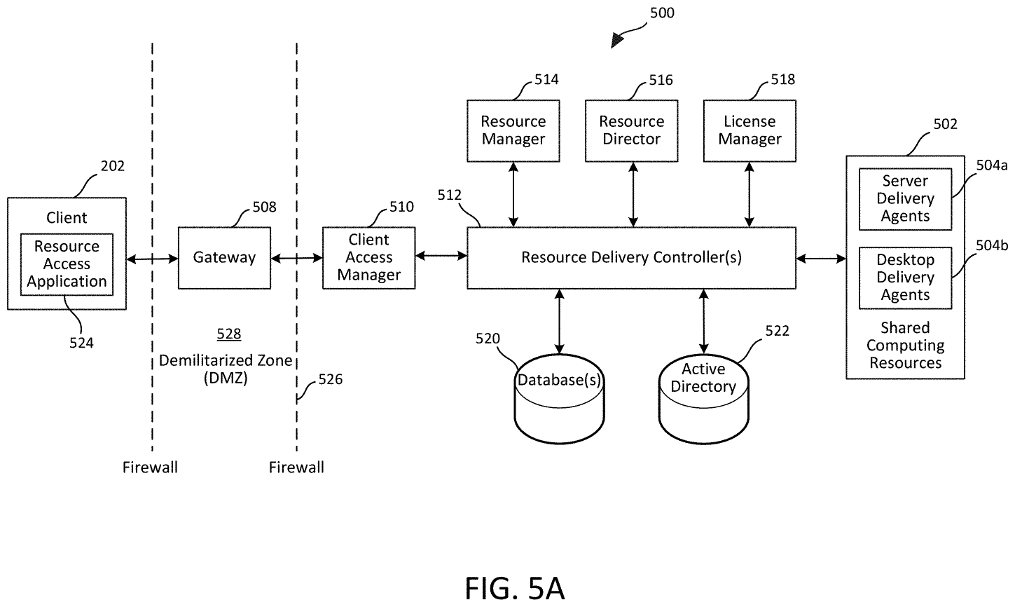

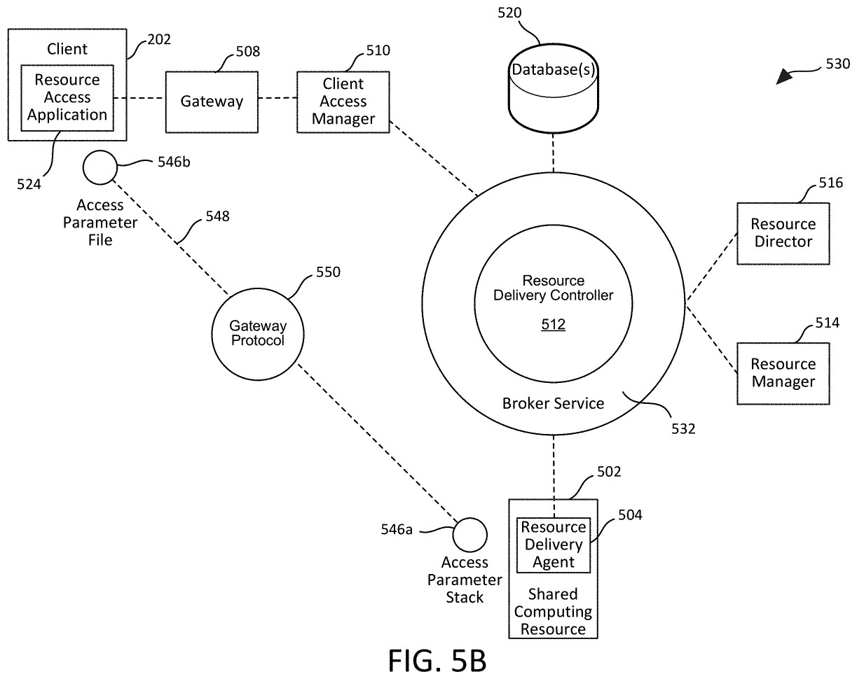

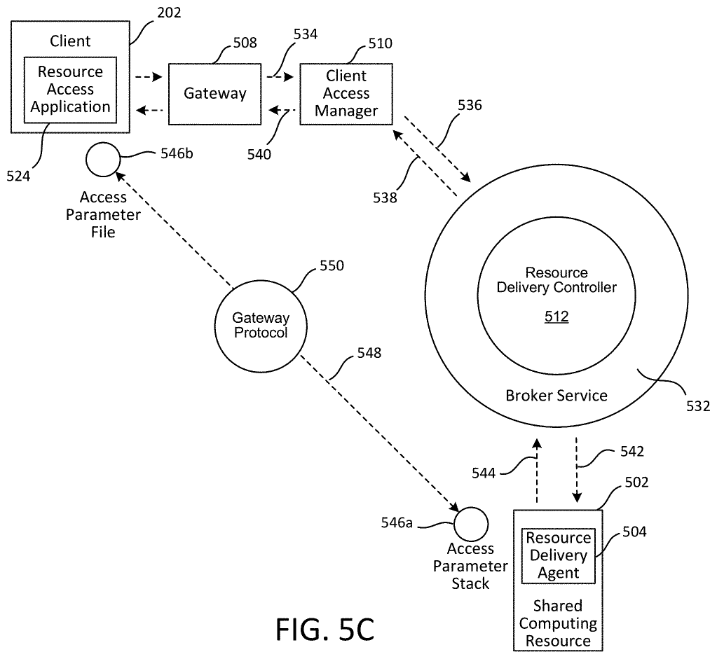

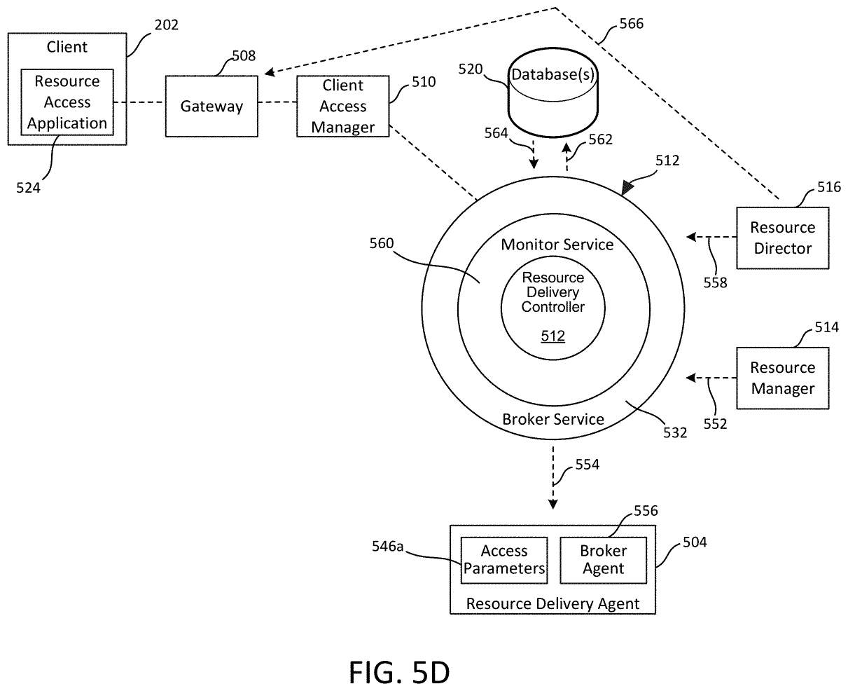

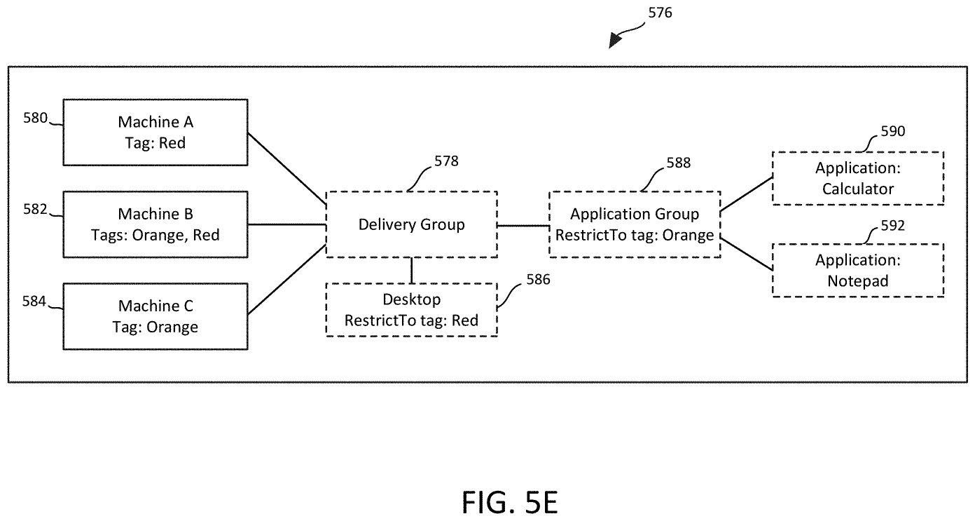

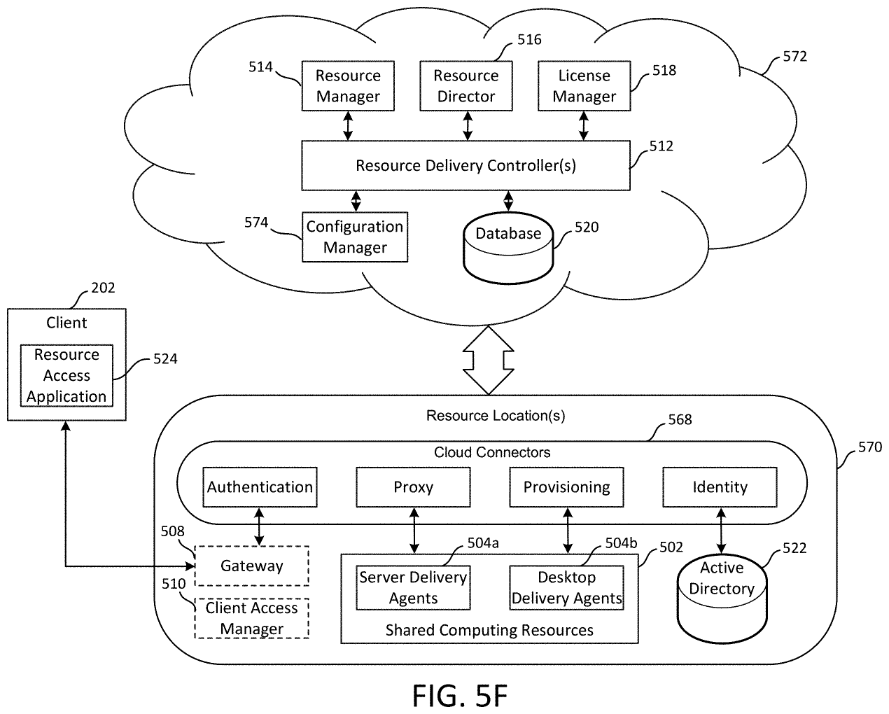

Offered is a system in which a mobile device (e.g., a computing device with a touchscreen) can provide additional user interface (UI) functionality for a remote computing environment that improves the user experience by supplementing the UI of the delivered virtual desktop for that environment. An example implementation of such a system 100 is shown in FIG. 1A. As shown, the system 100 may include a mobile device 102, e.g., a smartphone or a tablet, a remote computing system 104 (e.g., including one or more servers 204—examples of which are described below), and one or more external monitors 106. In some implementations, the mobile device 102 may be a client device 202 (examples of which are described in detail below), and may be running a mobile operating system, such as iOS or Android. Although not shown in FIG. 1A, in some implementations, the mobile device 102 may include or be capable of accessing a resource access application 524 of the type described below (in Section E) in connection with FIGS. 5A-F. The Citrix Workspace app for iOS is an example of such a resource access application 524.

In some implementations, the remote computing system 104 may include a shared computing resource 502 of the type described in connection with FIGS. 5A-F. In such implementations, the remote computing system 104 may provide a computing environment that can be delivered to the mobile device 102. In particular, as Section E describes, a resource delivery agent 504 may deliver a virtual desktop for the remote computing environment to the mobile device 102. As indicated by arrows 108 and 110 in FIG. 1A, the remote computing system 104 may send data or content (e.g., graphics content) for the virtual desktop of the remote computing environment to the mobile device 102 (e.g., from the resource delivery agent 504 of the shared computing resource 502 to the resource access application 524 of the mobile device 102), and the mobile device 102 may forward the received content to the external monitor(s) 106 for presentation within a window 112. Although not shown in FIG. 1A, it should be appreciated that, in some implementations, the window 112 in which the received content for the virtual desktop is displayed may be extended across (or mirrored by) multiple external monitors 106. The external monitor(s) 106 may be connected to the mobile device 102 via any of a number or wired or wireless technologies, such as a Type C cable, Bluetooth, etc.

As indicated by an arrow 114 in FIG. 1A, the mobile device 102 may send data (e.g., UI control data) for the virtual desktop to the remote computing system 104 (e.g., from the resource access application 524 of the mobile device 102 to the resource delivery agent 504 of the shared computing resource 502). In some implementations, such data may correspond to user input(s) to a portion of a touchscreen 116, such as touch selections on a displayed keyboard or touch gestures for controlling a cursor. In other implementations, such data may additionally or alternatively correspond to user input(s) to one or more external devices or components (e.g., UI components) 118, such as an external keyboard 118a and/or an external mouse 118b. As indicated by an arrow 120 in FIG. 1A, such component(s) 118 may communicate data (e.g., mouse clicks, keystrokes, etc.) to the mobile device 102. The component(s) 118 may be connected to the mobile device 102 via any of a number or wired or wireless technologies, such as a Type C cable, Bluetooth, etc.

In some implementations, the content for the delivered desktop (per the arrow 108) and the data for the desktop (per the arrow 114) may be communicated over respective communication channels established between the mobile device 102 and the remote computing system 104. As explained in more detail in Section G, for example, in some implementations, one or more virtual channels may be established (e.g., as independent computing architecture (ICA) virtual channels) between respective drivers (e.g., virtual drivers 702) of a resource access application 524 of the mobile device 102 and corresponding engines 704 of the resource delivery agent 504 of the shared computing resource 502. In other implementations, other types of communication channels (e.g., different time slots, different frequency channels, different code division multiple access (CDMA) channels, etc.) may additionally or alternatively be employed to communicate the content for the delivered desktop (per the arrow 108) and the data for the desktop (per the arrow 114), respectively. As such, a user may view a virtual desktop for a remote computing environment within the window 112 of the external monitor(s) 106 and may interact with one or more applications presented within that delivered desktop via one or more components 118 and/or via UI controls presented in a portion of the touchscreen 116.

Advantageously, rather than utilizing the mobile device 102 simply to display some or all of the delivered virtual desktop, and possibly enabling user input with respect to that virtual desktop (e.g., to input keystrokes or control a cursor), the system 100 may be configured to enable the touchscreen 116 to present additional UI functionality (e.g., by displaying additional UI content 122) for the remote computing environment that is being delivered to the mobile device 102, thus enabling a user of the mobile device 102 to interact with the delivered computing environment in new and beneficial ways.

Several examples of such additional UI content 122a-c that may be presented on the touchscreen 116 are described below in connection with FIGS. 1B-D, respectively. As indicated by an arrow 120 in FIG. 1A, in some implementations, data for one or more such additional touchscreen functionalities may be exchanged between the remote computing system 104 and the mobile device 102 (e.g., between the resource delivery agent 504 of the shared computing resource 502 and the resource access application 524 of the mobile device 102). As described below in Section G, for example, in some implementations, such data may be exchanged via one or more communication channels (e.g., ICA virtual channels).

Referring now to FIGS. 1B-D, in the illustrated examples, different screens of additional UI content 122 may be accessed by selecting respective tabs 124a-c displayed on the touchscreen 116, and particular mechanisms are shown for organizing and selecting the various displayed elements. It should be appreciated, however, that any of a number or alternative techniques may be used to present and/or enable access to different types and/or items of additional UI content 122. The optimal mode of presentation/access to the various types/items of additional UI content 122 may, for example, depend on the type of mobile device 102 being used to present the additional UI content and/or the size/dimensions of the touchscreen 116 of the mobile device 102. For example, in implementations in which the mobile device 102 is a tablet, it may make sense to display two or more types of additional UI content 122 simultaneously on the touchscreen 116. In such implementations, for instance, it may be preferable to simultaneously display the additional UI content 122a (shown in FIG. 1B), the additional UI content 122b (shown in FIG. 1C), and/or the additional UI content 122c (shown in FIG. 1D), on the same screen, rather than switching between multiple screens via tabs 124 or the like.

As shown in FIG. 1B, in some implementations, in response to selecting the “applications” tab 124a, the touchscreen 116 may present application icons 126 corresponding to respective applications that are included within the remote computing environment being delivered to the mobile device 102, and that are accessible via the virtual desktop presented on the external monitor(s) 106. Example techniques for identifying the available applications of the delivered computing environment are described below in Section G. As FIG. 1B illustrates, in some implementations, the application icons 126 may resemble the icons for mobile applications that users are accustomed to seeing on their mobile devices. As also shown, in some implementations, such application icons 126 may additionally be organized within one or more folders 128, similar to the manner in which users commonly organize other mobile application icons on their devices. In some implementations, the manner in which application icons 126 are presented and organized may be left to the user's discretion, such as by permitted to user to select and move the application icons 126 about the touchscreen 116, among folders 128, etc., as just described. In other implementations, the system 100 may additionally or alternatively identify (e.g., automatically identify) the applications the user accesses the most frequently and/or accessed the most recently, and may present application icons 126 for such applications closer to the top of the touchscreen 116 or otherwise make those application icons 126 more readily accessible on the mobile device 102. In still other implementations, as described in more detail below, the user may be presented with one or more selectable options for sorting and/or filtering the application icons 126 that are presented on the touchscreen 116.

In response to the selection of an application icon 126 on the touchscreen 116, if the corresponding application has not yet been launched on the remote computing system 104, the system 100 may cause the application to be launched and presented within a new window of the virtual desktop that is being delivered to the mobile device 102 and displayed on the external monitor(s) 106. For example, in some implementations, the selected application may be launched on a shared computing resource 502 (described in Section E) that is hosting the virtual desktop being delivered to the mobile device 102. If, on the other hand, the application corresponding to a selected application icon 126 has already been launched on the remote computing system 104 (e.g., a shared computing resource 502), the system 100 may instead cause an existing window for that application to be un-minimized, maximized, and/or brought to the foreground of the virtual desktop that is being delivered to the mobile device 102 and displayed on the external monitor(s) 106. Such control of the window for the selected resource may be accomplished, for example, by sending an appropriate instruction to a component of the resource delivery agent 504 (described in Section E) that is overseeing delivery of the content for virtual desktop to the mobile device 102. Accordingly, this technique may greatly facilitate a user's ability to quickly access or switch to a desired application within the virtual desktop, regardless of the number of application windows the user currently has open and/or the current state (maximized, minimized, or set size) of those windows.

As shown in FIG. 1C, in some implementations, in response to selecting the “files” tab 124b, the touchscreen 116 may present file UI elements 130 corresponding to respective files that are accessible via the virtual desktop being presented on the external monitor(s) 106. Example techniques for identifying accessible files are described below in Section G. As FIG. 1C illustrates, in some implementations, the touchscreen 116 may additionally be presented with one or more selectable options 132 for sorting the identified files to make it easier for the user to locate a desired file. In the illustrated example, the indicated options allow sorting by (A) when the files were most recently accessed, (B) how frequently the files have been accessed over some period of time, (C) when the files were most recently modified, (D) the names of the files, (E) the size of the files, or (F) when the files were created. Although not shown in FIG. 1C, it should be appreciated that one or more options for filtering the file UI elements 130 may additionally or alternatively be presented. For instance, in some implementations, one or more options may be presented for allowing filtering of files by file extension type, e.g., “.docx”, “.pptx”, “.mpeg.”, etc. In the illustrated example, the sorting/filtering options are selectable via checkboxes. Other selection techniques may additionally or alternatively be used in other implementations, however. Further, in some implementations, the selectable sorting/filtering options may be grouped and nested, and individual options may be accessed, for example, by selectively expanding a hierarchically organized menu.

In response to the selection of a file UI element 130 on the touchscreen 116, if the application needed to access the corresponding file has not yet been launched on the remote computing system 104, the system 100 may cause the application to be launched and used to open the selected file within a new window of the virtual desktop that is being delivered to the mobile device 102 and displayed on the external monitor(s) 106. For example, in some implementations, the requisite application may be launched on a shared computing resource 502 (described in Section E) that is hosting the virtual desktop being delivered to the mobile device 102. If, on the other hand, the application needed to open the selected file has already been launched on the remote computing system 104, the system 100 may instead simply cause the file to be opened within a new window for that application within the delivered virtual desktop. In some implementations, for example, a component of the resource delivery agent 504 (described in Section E) that is overseeing delivery of the content for virtual desktop to the mobile device 102 may be instructed to open the selected file within a new window. Accordingly, this technique may greatly facilitate a user's ability to quickly access a desired file within the virtual desktop.

As shown in FIG. 1D, in some implementations, in response to selecting the “notifications” tab 124c, the touchscreen 116 may present notification elements 134 corresponding to respective notifications that have been generated for applications executing in the remote computing environment that is being delivered to the mobile device 102. Example techniques for identifying such notifications are described below in Section G. As FIG. 1D illustrates, in some implementations, the touchscreen 116 may additionally be presented with one or more selectable options 136 for sorting and/or filtering the identified notifications based on user preferences. In the illustrated example, the touchscreen 116 includes selectable options 136 to present either the most recent notifications or the oldest notifications first, as well as to sort the notifications by application and/or by sender (e.g., if the notifications relates to a new email or other message). In the example shown, the touchscreen 116 further includes a number of selectable options 136 for filtering the notification elements 134 by indicating whether “unread” and/or “read” notifications are to be listed, as well as to select one or more particular applications for which notification elements 134 are to be presented.

In response to the selection of a notification element 134 on the touchscreen 116, the system 100 may cause a window for the application responsible for the notification to be opened and/or brought to the foreground within the virtual desktop that is being delivered to the mobile device 102 and displayed on the external monitor(s) 106. For instance, if a selected notification element 134 was generated based on a new message received by a messaging application, the window for that messaging application may be brought to the foreground of the virtual desktop and/or or the newly-received message may be opened in a new window on the virtual desktop. Such control of a window for an application responsible for a selected notification may be accomplished, for example, by sending an appropriate instruction to a component of the resource delivery agent 504 (described in Section E) that is overseeing delivery of the content for virtual desktop to the mobile device 102. As shown in FIG. 1D, in some implementations, the respective notification elements 134 may additionally include indicators 138 (e.g., red versus green dots) to show whether the individual notification elements 134 presented on the display screen have been previously selected by the user, and/or may be provided with respective “close” UI elements 140 that can be selected to clear individual notification elements 134 from the list of notification elements 134 presented on the touchscreen 116. Accordingly, this technique may enhance a user's ability to manage and/or respond to various notifications for applications that are executing within the remote computing environment that is being delivered to the mobile device 102 and presented on the external monitor(s) 106.

Additional details and example implementations of embodiments of the present disclosure are set forth below in Section G, following a description of example systems and network environments in which such embodiments may be deployed.

### B. Network Environment

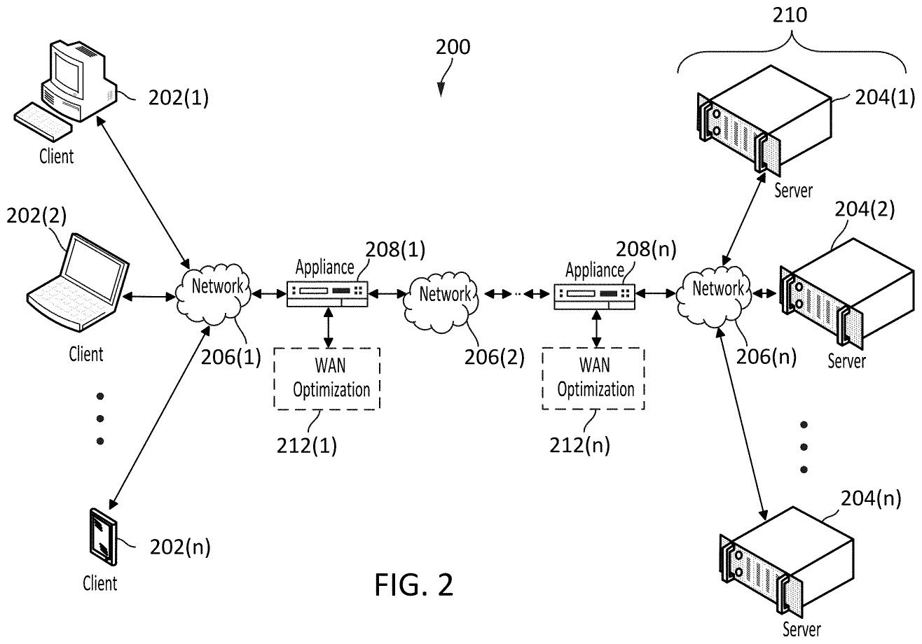

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

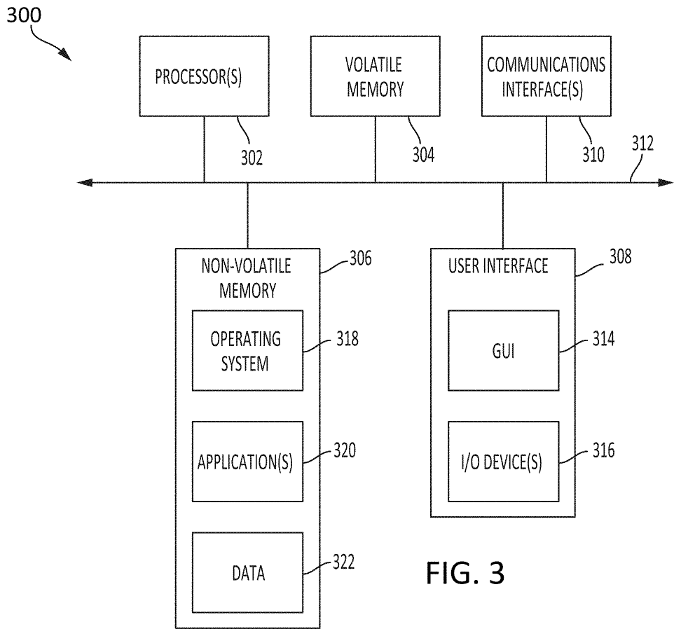

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

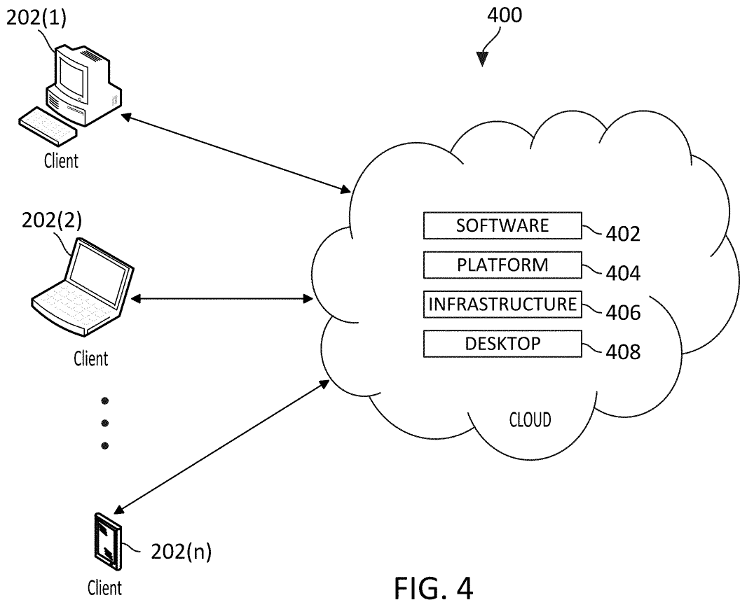

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Wash., Azure IaaS provided by Microsoft Corporation or Redmond, Wash., RACKSPACE CLOUD provided by Rackspace US, Inc., of San Antonio, Tex., Google Compute Engine provided by Google Inc. of Mountain View, Calif., and RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile® from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.
E. Systems and Methods for Delivering Virtualized Applications and/or Desktops to Client Devices

FIG. 5A is a block diagram illustrating key components of a resource delivery system 500 that may enable a client device 202 to remotely access one or more virtual applications or desktops running on one or more shared computing resources 502. The shared computing resources 502 may include physical machines and/or virtual (e.g., hypervisor driven) machines, and may be located at a data center, within a cloud computing environment, or elsewhere. As described in more detail below, such shared computing resources 502 may implement one or more resource delivery agents 504, including one or more server delivery agents 504a and/or one or more desktop delivery agents 504b. The Virtual Delivery Agents (VDAs) of the Citrix Virtual Apps and Desktops™ system offered by Citrix Systems, Inc., of Fort Lauderdale, Fla., are example implementations of the resource delivery agents 504. In some implementations, the resource delivery system 500 may give an information technology (IT) department of an organization control of virtual machines, applications, licensing, and security while providing “anywhere access” for any device. As described below, the resource delivery system 500 may enable end users to run applications and/or desktops independently of the operating system and interface of the end user's device. Further, the resource delivery system 500 may enable administrators to manage the network and control access from selected devices or from all devices, as well as to manage an entire network from a single data center.

The resource delivery system 500 shown in FIG. 5A may, for example, correspond to an implementation of a Citrix Virtual Apps and Desktops™ system offered by Citrix Systems, Inc., of Fort Lauderdale, Fla. Such systems employ a unified architecture called FlexCast Management Architecture (FMA). Among other things, FMA provides the ability to run multiple versions of Citrix Virtual Apps or Citrix Virtual Desktops™ as well as integrated provisioning.

As shown in FIG. 5A, in addition to the shared computing resources 502, the resource delivery system 500 may include a gateway 508, a client access manager 510, one or more resource delivery controllers 512, a resource manager 514, a resource director 516, a license manager 518, one or more databases 520, and an Active Directory (AD) 522 or other directory service.

The resource delivery controller(s) 512 may be the central management component of the resource delivery system 500. In some implementations, the resource delivery controller(s) 512 may be installed on at least one server in a data center of an organization. The Delivery Controller of the Citrix Virtual Apps and Desktops™ system offered by Citrix Systems, Inc., of Fort Lauderdale, Fla., is one example implementation of the resource delivery controller(s) 512. For reliability and availability, respective resource delivery controllers 512 may be installed on multiple servers. The resource delivery controller(s) 512 may communicate with the shared computing resources 502 to distribute applications and/or desktops, authenticate and manage user access, broker connections between client devices 202 and resource delivery agents 504 running on respective shared computing resources 502, optimize use connections, and/or load-balance use connections. As described in more detail below, a broker service 532 (shown in FIGS. 5B-5D) of the resource delivery controller(s) 512 may interact with the database(s) 520 to track which users are logged on and where, what session resources the users have, and if users need to reconnect to existing applications. In some implementations, the broker service 532 may execute PowerShell commands and communicate with broker agents 556 (shown in FIG. 5D) of the resource delivery agents 504 over transmission control protocol (TCP) port “80.” A monitor service 560 (shown in FIG. 5D) may also be provided by the resource delivery controller(s) 512 to collect historical data concerning the operation of the resource delivery controller(s) 512 and write such data to the database(s) 520. In some implementations, such a monitor service 560 may use TCP port “80” or “443.”

The resource delivery controller(s) 512 may manage the state of desktops, starting and stopping them based on demand and administrative configuration. In some implementations, the resource delivery controller(s) 512 may also enable the adjustment of user profiles (stored within the database(s) 520) to manage user personalization settings in virtualized or physical Windows environments.

In some implementations, the database(s) 520 may include at least one Microsoft Structured Query Language (SQL) Server database in which configuration and session information may be stored. As noted above, the database(s) 520 may store the data collected and managed by the services that make up the resource delivery controller(s) 512. In some implementations, the database(s) 520 may be provided within a data center of an organization and may have a persistent connection to the resource delivery controller(s) 512. Although not illustrated in FIG. 5A, it should be appreciated that the resource delivery system 500 may also include respective databases associated with the resource manager 514, the resource director 516, and the license manager 518 to store data collected and/or used by those components.

The resource delivery agents 504 may be installed on physical or virtual machines that are made available to deliver applications or desktops to users. The resource delivery agents 504 may enable such machines to register with the resource delivery controller(s) 512. The registration of a machine with the resource delivery controller(s) 512 may cause that machine and the resources it is hosting to be made available to users. The resource delivery agents 504 may establish and manage the connections between the machines on which they are installed and client devices 202. The resource delivery agents 504 may also verify that a license is available for the user and/or session, and may apply policies that are configured for the session.

The resource delivery agents 504 may communicate session information to the broker service 532 (shown in FIGS. 5B-5D) of the resource delivery controller(s) 512 through the broker agents 556 (shown in FIG. 5D) in the resource delivery agents 504. Such broker agents 556 may host multiple plugins and collect real-time data. In some implementations, the broker agents 556 may communicate with the resource delivery controller(s) 512 over TCP port “80.” In some implementations, the resource delivery agents 504 may operate with Single-session and/or Multi-session Windows operating systems. The resource delivery agents 504 for Multi-session Windows operating systems may allow multiple users to connect to the server at one time. The resource delivery agents 504 for Single-session Windows operating systems, on the other hand, may allow only one user to connect to the desktop at a time. In some implementations, one or more the resource delivery agents 504 may alternatively operate with a Linux operating system.

When users connect from outside one or more corporate firewalls, e.g., firewalls 526a and 526b shown in FIG. 5A, the gateway 508 may be used to secure such connections with Transport Layer Security (TLS). The gateway 508 may, for example, be a Secure Socket Layer (SLL) Virtual Private Network (VPN) appliance that is deployed in a demilitarized zone (DMZ) 528. The gateway 508 may thus provide a single secure point of access through the corporate firewall 526.

The client access manager 510 of the resource delivery system 500 may authenticate users and manage stores of desktops and/or applications that are available for users to access. In some implementations, the client access manager 510 may provide an application “storefront” for an enterprise, which may provide users with self-service access to the desktops and/or applications that the enterprise opts to make available to them. In some implementations, the client access manager 510 may also keep track of users' application subscriptions, shortcut names, and other data. Tracking such data may, for example, help ensure that users have a consistent experience across multiple devices.

As shown in FIG. 5A, a resource access application 524 may be installed on client devices 202 or other endpoints (such as virtual desktops). Such resource access applications 524 may provide users with quick, secure, self-service access to documents, applications, and/or desktops. The resource access application 524 may, for example, provide on-demand access to Windows, web, and/or Software as a Service (SaaS) applications. The Citrix Workspace™ app, offered by Citrix Systems, Inc., of Fort Lauderdale, Fla., is one example implementation of such a client-based version of the resource access application 524. In some implementations, the resource access application 524 may alternatively operate on a web server (not shown in FIG. 5A) and may be accessed using a web browser (also not shown in FIG. 5A) installed on the client device 202. In some embodiments, for example, the resource access application 524 may be provided as a hypertext markup language 5 (HTML5) service and may be accessed using an HTML5-compatible web browser. The Citrix Workspace™ app for HTML5, offered by Citrix Systems, Inc., of Fort Lauderdale, Fla., is one example implementation of such a web-based version of the resource access application 524.

In some embodiments, the resource access application 524 may intercept network communications from a network stack used by the one or more applications. For example, the resource access application 524 may intercept a network communication at any point in a network stack and redirect the network communication to a destination desired, managed, and/or controlled by the resource access application 524, for example, to intercept and redirect a transport layer connection to an IP address and port controlled and/or managed by resource access application 524. The resource access application 524 may thus, in some embodiments, transparently intercept any protocol layer below the transport layer, such as the network layer, and any protocol layer above the transport layer, such as the session, presentation, or application layers. The resource access application 524 may, for example, interface with the transport layer to secure, optimize, accelerate, route, and/or load-balance any communications provided via any protocol carried by the transport layer.

In some embodiments, the resource access application 524 may be implemented as an Independent Computing Architecture (ICA) client developed by Citrix Systems, Inc. The resource access application 524 may perform acceleration, streaming, monitoring, and/or other operations. For example, the resource access application 524 may accelerate streaming an application from a shared computing resource 502 running a resource delivery agent 504 to the client device 202. The resource access application 524 may also perform endpoint detection/scanning and/or collect endpoint information about the client 202. For example, the resource access application 524 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The resource manager 514 shown in FIG. 5A, may provide a console from which the configuration and management of applications and desktops that are to be made available to users may be controlled. The Studio component of the Citrix Virtual Apps and Desktops™ system offered by Citrix Systems, Inc., of Fort Lauderdale, Fla., is one example implementation of the resource manager 514. In some implementations, the resource manager 514 may eliminate the need for separate management consoles for managing delivery of applications and desktops. In some embodiments, the resource manager 514 may provide one or more wizards to guide system administrators through environment setup, creating workloads to host applications and desktops, and assigning applications and desktops to users. In some implementations, the resource manager 514 may also be used to allocate and track licenses for the resource delivery system 500. In some embodiments, the resource manager 514 may get the information it displays from the broker service 532 of the resource delivery controller(s) 512, e.g., communicating over TCP port “80.”

The resource director 516 may, for example, be a web-based tool that enables IT support and help desk teams to monitor an environment, troubleshoot issues before they become system-critical, and perform support tasks for end users. The Director component of the Citrix Virtual Apps and Desktops™ system offered by Citrix Systems, Inc., of Fort Lauderdale, Fla., is one example implementation of the resource director 516. In some implementations, a single deployment of the resource director 516 may be used to connect to and monitor multiple resource delivery systems 500, such as that shown in FIG. 5A. Examples of information that may be displayed by the resource director 516 include (A) real-time session data from the broker service 532 of the resource delivery controller(s) 512, which may include data the broker service 532 gets from the broker agent 556 in the resource delivery agents 504, and (B) historical data about the resource delivery system 522 that may be received, for example, from the monitor service 560 in the resource delivery controller(s) 512. In some implementations, the resource director 516 may use performance and heuristics data captured by the gateway 508 (described below) to build analytics from the data and then presents such analytics to system administrators. Further, in some implementations, the resource director 516 may allow system administrators to view and interact with a user's sessions, e.g., using Windows Remote Assistance.

The license manager 518, as its name implies, may enable the management of licenses within the resource delivery system 500. In some implementations, the license manager 518 may communicate with the resource delivery controller(s) 512 to manage licensing for a user's session and with the resource manager 514 to allocate license files.

As noted above, in some implementations, the shared computing resources 502 shown in FIG. 5A may include one or more virtual machines. These can be virtual machines that are used to host applications and/or desktops, as well as virtual machines that are used to host the other components of the resource delivery system 500. In some implementations, a hypervisor may be installed on a host computer to run the hypervisor and hosting virtual machines.

Although not depicted in FIG. 5A, in some implementations, the resource delivery system 500 may additionally include a performance monitoring service or agent. In some embodiments, one or more dedicated servers (or a dedicated service in a cloud-based environment) may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., as a part of the resource access application 524), one or more servers 204, or one or more other system component(s). In general, the monitoring agents may execute transparently (e.g., in the background) to any application and/or user of the device. In some embodiments, such a monitoring agent may be implemented as components of Citrix Analytics™ by Citrix Systems, Inc., of Fort Lauderdale, Fla.

The monitoring agents may, for example, monitor, measure, collect, and/or analyze data on a frequency (e.g., a predetermined frequency), based upon an occurrence of given event(s), or in real time during operation of the resource delivery system 500. The monitoring agents may, for example, monitor resource consumption and/or performance of hardware, software, and/or communications resources of the clients 202, the gateway 508 (and/or any other components in the DMZ 528), and/or the resource delivery controller(s) 512, the shared computing resources 502, the resource delivery agents 504, or any other components shown in FIG. 5A. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the resource delivery system 500. For example, based upon one or more monitored performance conditions or metrics, the resource delivery system 500 may be dynamically adjusted, for example periodically or in real-time, to optimize application delivery by the resource delivery agents 504 to the clients 202 based upon network environment performance and conditions

FIG. 5B illustrates an example deployment 530 of a resource delivery system 500, such as that shown in FIG. 5A. Such a deployment may be referred to as a “Site.” A Site may be made up of machines with dedicated roles that allow for scalability, high availability, and failover, and may provide a solution that is secure by design. As discussed above, such a Site may include servers and/or desktop machines installed with resource delivery agents 504, and one or more resource delivery controller(s) 512, which may manage access to such servers/machines. FIG. 5B illustrates one such resource delivery agent 504, and one such resource delivery controller 512. As shown in FIG. 5B, the resource delivery controller 512 may include a broker service 532. The resource delivery agent 504 may enable users to connect to desktops and/or applications. It may be installed on server or desktop machines in a datacenter for most delivery methods, but it may also be installed on physical personal computers (PCs) for Remote PC Access. In some implementations, the resource delivery controller 512 may be made up of independent Windows services that may manage resources, applications, and/or desktops, and may optimize and balance user connections.

In some embodiments, client devices 202 may not directly access the resource delivery controller 512. Instead, the resource delivery agent 504 and the client access manager 510 may serve as intermediaries between client devices 202 and the resource delivery controller 512. When users log on using the client access manager 510, their credentials may pass through to the broker service 532 on the resource delivery controller 512. The broker service 532 may then obtain profiles and available resources based on the policies set for them.

FIG. 5C illustrates an example process for handling user connections within the deployment 530 shown in FIG. 5B. As indicated by arrows 534 and 535, to start a session, a user may cause the client device 202 to connect (via the gateway 508) to the client access manager 510. Such a connection may, for example, be established using the resource access application 524. As noted above, the resource access application 524 may either be installed on the client device 202 or accessible from a web server via a web browser on the client device 202.

As indicated by arrow 536, the user's credentials may then move through this pathway to access the broker service 532 of resource delivery controller 512. In some implementations, such communications may be encrypted to protect the security of such credentials. The broker service 532 may determine which desktops and/or applications the user is allowed to access. After the credentials have been verified, information about available applications and/or desktops may be sent back to the client device 202 through the pathway between the client access manager 510 and the resource access application 524, as indicated by arrows 538, 540, and 541. The user of the client device 202 may thus be provided with a list of available applications and/or desktops. When the user selects an application or desktop from this list, an indication of the selected resource goes back down the previously described pathway to the resource delivery controller 512. The resource delivery controller 512 may then select an appropriate resource delivery agent 504 to host the selected applications or desktop.

As indicated by arrow 542, the resource delivery controller 512 may send a message to the selected resource delivery agent 504 with the user's credentials, and may then send pertinent data about the user and the connection to the resource delivery agent 504. The resource delivery agent 504 may then accept the connection and, as indicated by arrows 544, 538, 540, and 541, may send a set of access parameters (stored in an access parameter stack 546a) back through the same pathways to the resource access application 524. In particular, the set of access parameters may be collected by the client access manager 510 and then sent to the resource access application 524 where they may be stored as an access parameter file 546b. In some implementations, the access parameter file 546b may be created as part of a protocol conversation between the client access manager 510 and the resource access application 524. In other implementations, the client access manager 510 may convert the access parameters to the file 546b, and that file 546b may then be downloaded to the client device 202. In some implementations, the access parameters may remain encrypted throughout this process.

The access parameter file 546b that is then stored on the client device 202 may be used to establish a direct connection 548 between the client device 202 and the access parameter stack 546a running on the resource delivery agent 504. As illustrated, the connection 548 between the client device 202 and the resource delivery agent 504 may use a gateway protocol 550. In some implementations, the gateway protocol 550 may include a feature that enables the client device 202 to immediately reconnect to the resource delivery agent 504 if the connection 548 is lost, rather than having to relaunch through the management infrastructure (including the client access manager 510, the resource delivery controller 512, etc.).

After the client device 202 connects to the resource delivery agent 504, the resource delivery agent 504 may notify the resource delivery controller 512 that the user is logged on. The resource delivery controller 512 may then send this information to the database(s) 520 (shown in FIGS. 5A, 5B and 5D) and the monitor service 560 (shown in FIG. 5D) of the delivery controller 512 may also start logging data in the database(s) 520.

Such sessions between client devices 202 and resource delivery agents 504 produce data that system administrators can access through the resource manager 514 and/or the resource director 516. FIG. 5D shows examples of paths through which the resource manager 514 and the resource director 516 may access such data in some embodiments. As indicated by the arrows 552 and 554, administrators may use the resource manager 514 to access real-time data from the broker agent 556 of a resource delivery agent 504 (via the broker service 532 of the resource delivery controller 512). The resource director 516 may access the same data, as indicated by arrows 558 and 554, plus any historical data the monitor service 560 of the resource delivery controller 512 stores in the database(s) 520, as indicated by arrows 558, 562 and 564. Further, as indicated by arrow 566, the resource director 516 may also access data from the gateway 508 for help desk support and troubleshooting.

Within the resource delivery controller 512, the broker service 532 may report session data for every session on the machine providing real-time data. The monitor service 560 may also track the real-time data and store it as historical data in the database(s) 520. In some implementations, the resource manager 514 may communicate with the broker service 532 and may access real-time data. The resource director 516 may communicate with the broker service 532 to access the database(s) 520.

An example process for enabling the delivery of applications and/or desktops will now be described. First, the machines that are to deliver applications and/or desktops may be set up with “Machine Catalogs.” Then, “Delivery Groups” may be created that specify the applications and/or desktops that are to be made available (using machines in the Machine Catalogs), and which users can access them. In some implementations, “Application Groups” may also be created to manage collections of applications.

Machine Catalogs are collections of virtual or physical machines that can be managed as a single entity. These machines, and the application and/or virtual desktops on them, are the resources that may be made available to users. All the machines in a Machine Catalog may have the same operating system and the same resource delivery agent 504 installed. They may also have the same applications and/or virtual desktops.

In some implementations, a master image may be created and used to create identical virtual machines in the catalog. For virtual machines, the provisioning method may be specified for the machines in that catalog. Valid machine types may, for example, include “Multi-session OS,” “Single-session OS,” and “Remote PC access.” A Multi-session OS machine is a virtual or physical machine with a multi-session operating system. Such a machine may be used to deliver published applications (also known as server-based hosted applications) and published desktops (also known as server-hosted desktops). These machines may allow multiple users to connect to them at one time. A Single-session OS machine is a virtual or physical machine with a single-session operating system. Such a machine may be used to deliver Virtual Desktop Infrastructure (VDI) desktops (desktops running single-session OSs that can optionally be personalized), virtual machine (VM)-hosted apps (applications from single-session OSs), and hosted physical desktops. Only one user at a time can connect to each of these desktops. A Remote PC access machine may enable remote users to access their physical office PCs from any device running the resource access application 524.

Delivery Groups may specify which users can access which applications and/or desktops on which machines. Delivery Groups may include machines from the Machine Catalogs, and Active Directory users who have access to the Site. In some implementations, users may be assigned to Delivery Groups by their Active Directory group, because Active Directory groups and Delivery Groups are ways to group users with similar requirements.

Delivery Groups may contain machines from more than one Machine Catalog, and Machine Catalogs may contribute machines to more than one Delivery Group. In at least some implementations, however, individual machines can only belong to one Delivery Group at a time.

The specific resources that users in the Delivery Group can access may be defined. For example, to deliver different applications to different users, all of the applications may be installed on the master image for one Machine Catalog and enough machines may be created in that catalog to distribute among several Delivery Groups. Delivery Groups may then be configured to deliver a different subset of applications that are installed on the machines.

Application Groups may provide application management and resource control advantages over using more Delivery Groups. Using a “tag restriction” feature, existing machines may be used for more than one “publishing” task, saving the costs of deployment and managing additional machines. A tag restriction can be thought of as subdividing (or partitioning) the machines in a Delivery Group. Application Groups may also be helpful when isolating and troubleshooting a subset of machines in a Delivery Group.

“Tags” may be strings that identify items such as machines, applications, desktops, Delivery Groups, Application Groups, and policies. After creating a tag and adding it to an item, certain operations may be tailored to apply to only items that have a specified tag.

In some implementations, tags may be used to tailor search displays is the resource manager 514. For example, to display only applications that have been optimized for testers, a tag named “test” may be created and may then be added (applied) to those applications. A search performed by the resource manager 514 may then be filtered with the tag “test”.

In some implementations, tags may be used to “publish” applications from an Application Group or specific desktops from a Delivery Group, considering only a subset of the machines in selected Delivery Groups. Using an Application Group or desktops with a tag restriction may be helpful when isolating and troubleshooting a subset of machines in a Delivery Group.

In some implementations, tags may be used to schedule periodic restarts for a subset of machines in a Delivery Group. Using a tag restriction for machines may, for example, enable the use of new PowerShell cmdlets to configure multiple restart schedules for subsets of machines in a Delivery Group.

In some implementations, tags may be used to tailor the application (assignment) of particular policies to a subset of machines in Delivery Groups, Delivery Group types, or organizational units (OUs) of a Site that have (or do not have) a specified tag. For example, if a particular policy is to be applied only to the more powerful workstations, a tag named “high power” may be applied to those machines and the policy may be set to apply to only machines to which the high power tag has been applied. Tags may additionally or alternatively be applied to particular Delivery Groups and one or more policies may be set to apply only the Delivery Groups to which such tags have been applied.

In some embodiments, the resource manager 514 may be used to create or edit a tag restriction for a desktop in a shared Delivery Group or an Application Group. In some implementations, creating such a tag restriction may involve several steps. First, a tag may be created and then added (applied) to one or more machines. Second a group may be created or edited to include the tag restriction, thus restricting launches to machines with the applied tag. A tag restriction may extend the machine selection process of the broker service 532. In particular, the broker service 532 may select a machine from an associated Delivery Group subject to access policy, configured user lists, zone preference, and launch readiness, plus the tag restriction (if present). For applications, the broker service 532 may fall back to other Delivery Groups in priority order, applying the same machine selection rules for each considered Delivery Group.

FIG. 5E illustrates a simple layout in which tag restrictions may be used to limit which machines will be considered for certain desktop and application launches. In the illustrated example, a site 576 has one shared Delivery Group 578 configured with three machines 580, 582, 584 and one published desktop 586, and one Application Group 588 configured with two applications 590, 592. As shown, tags may be added to each of the three machines 580, 582, 584. A tag restriction named “Red” has been applied to the published desktop 586 in the shared Delivery Group 578, so that the published desktop 586 can be launched only on machines in that Delivery Group 578 that have the tag “Red,” i.e., the machines 580 and 582. A tag restriction named “Orange” has been applied to the Application Group 588, so that each of its applications 590, 592 (Calculator and Notepad) can be launched only on machines in the Delivery Group 578 that have the tag “Orange,” i.e., the machines 582 and 584. Since the machine 582 has both tags (Red and Orange), it can be considered for launching the applications 590, 592 and the desktop 586.

In some implementations, tags may be created, added (applied), edited, and/or deleted from selected items using the resource manager 514. Tag restrictions may, for example, be configured when creating or editing desktops in Delivery Groups and/or when creating or editing Application Groups.

As noted above, the resource delivery system 500 described in connection with FIGS. 5A-5D may provide virtualization solutions that give administrators control of virtual machines, applications, and security while providing anywhere access for any device. As was also noted above, the resource delivery system 500 may also enable end users to access applications and desktops independently of the operating systems and interfaces of the client devices 202 such end users are operating.

In some implementations, one or more components of the resource delivery system 500 may be provided as a service within a cloud-based computing environment. FIG. 5F illustrates an example of such an implementation. As shown in FIG. 5F, one or more cloud connectors 568 may enable various resources at one or more locations 570 outside of a cloud computing environment 572 to interface with various components within the cloud computing environment 572. As illustrated, resource location(s) 570 may include the machines and other resources that deliver applications and/or desktops to client devices 202. As indicated by dashed lines, the resource location 570 may optionally include the gateway 508 and/or the client access manager 510 previously described. In the illustrated example, the resource delivery controller(s) 512, the resource manager 514, the resource director 516, the license manager 518, and the database(s) 520 are all provided within the cloud computing environment 572. Further, as shown in FIG. 5F, a configuration manager 574 may additionally be hosted within the cloud computing environment 572 in some implementations. Examples of management functions that may be performed by the configuration manager 574 are described below. In some implementations, the cloud computing environment 572 may correspond to a public cloud computing infrastructure, such as AZURE CLOUD provided by Microsoft Corporation of Redmond, Wash., or AMAZON WEB SERVICES provided by Amazon.com, Inc., of Seattle, Wash.

In addition to serving as a channel for communication between the cloud computing environment 572 and the resource location(s) 570, the cloud connectors 568 may enable cloud management without requiring any complex networking or infrastructure configuration such as virtual private networks (VPNs) or Internet Protocol Security (IPsec) tunnels.

As noted above, the resource delivery controller(s) 512 may serve as the central control layer component in a deployment. The resource delivery controller(s) 512 may communicate through the cloud connectors 568 in each resource location 570 to distribute applications and/or desktops, authenticate and manage user access, broker connections between users and their virtual desktops and/or applications, optimize use connections, and/or load-balance use connections. In some implementations, the resource delivery controller(s) 512 may additionally track which users are logged on and where, which session resources the users have, and if users need to reconnect to existing applications. The resource delivery controller(s) 512 may further manage the state of desktops, starting and stopping them based on demand and administrative configuration, in some implementations.

The configuration manager 574 in the cloud computing environment 572 may (A) enable administrators to specify which services are to be made available to users via the resource access application, (B) customize the uniform resource locator (URL) that the resource access application 524 is to use to access the available resources, (C) customize the appearance of the user interface provided by the resource access application, such as logos, color, and preferences, (D) specify how users are to authenticate to the system, such as using the Active Directory 522, and/or (E) specify external connectivity for the resource locations 570.

As noted above, a resource location 570 may include at least one cloud connector 568 that serves as the communications channel between the components in the cloud computing environment 572 and the components in the resource location 570. In the resource location 570, the cloud connector(s) may act as a proxy for the resource delivery controller(s) 512 in the cloud computing environment 572.

As noted above, the physical or virtual machines that deliver applications and/or desktops may include resource delivery agents 504a, 504b. The resource delivery agents 504 may register with at least one cloud connector 568. After registration, connections may be brokered from those resources to users. The resource delivery agents 504 may further establish and manage the connection between the machine and the client device 202, and apply policies that are configured for the session. The resource delivery agents 504 may communicate session information to the cloud connector 568 through the broker agent 556 (shown in FIG. 5D) in the resource delivery agent 504. As noted above, in some implementations, such a broker agent 556 may host multiple plugins and collect real-time data.

A host connection may be established that enables communication between components in the cloud computing environment 572 and the resource delivery agents 504 on the shared computing resources 502. Specifications for such host connections may include (A) the address and credentials to access the host, (B) the tool that is to be used to create VMs, (C) the storage method to use, (D) the machines to use for storage, and/or (E) which network the VMs will use.

### F. Example Architecture of a Resource Virtualization Server

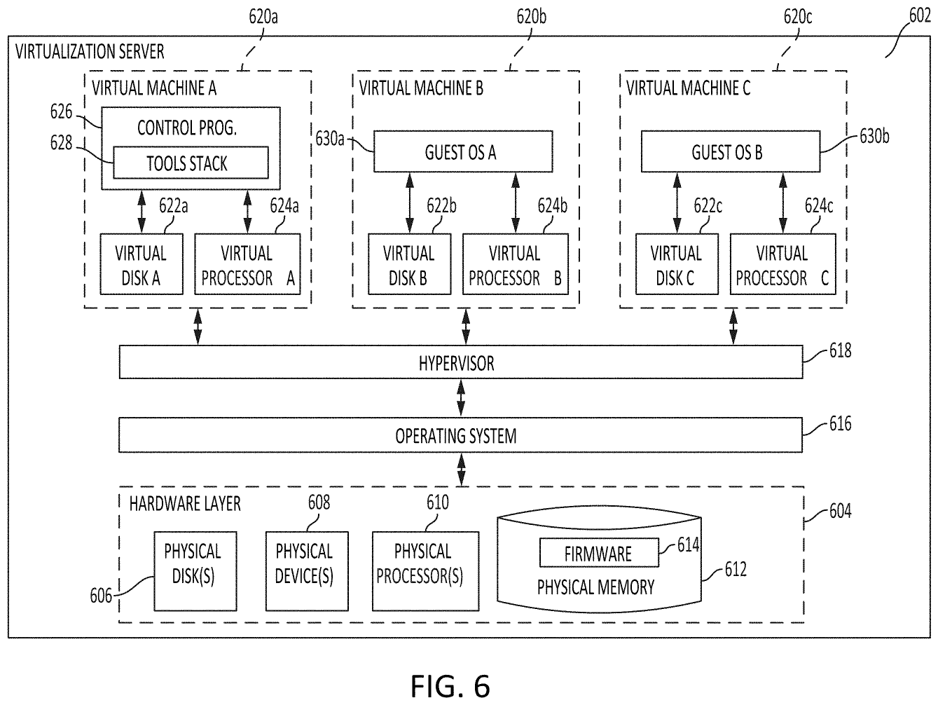

FIG. 6 shows an example architecture of an illustrative resource virtualization server 602. As shown, the resource virtualization server 602 may be configured to provide virtual desktops and/or virtual applications to one or more client access devices, such as the clients 202. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Instances of the operating system may be physical (e.g., one operating system per physical device) or virtual (e.g., many instances of an OS running on a single physical device). The applications may be executed on a local device, or executed on a remotely located device (e.g., remoted).

The virtualization server 602 illustrated in FIG. 6 may be deployed as and/or implemented by one or more of the servers 204 described above, the servers that make up a virtualization server system, or by other known computing devices. Included in the virtualization server 602 is a hardware layer 604 that may include one or more physical disks 606, one or more physical devices 608, one or more physical processors 610, and one or more physical memories 612. In some embodiments, firmware 614 may be stored within a memory element in physical memory 612 and be executed by one or more of the physical processors 610. The virtualization server 602 may further include an operating system 616 that may be stored in a memory element in physical memory 612 and executed by one or more of physical processors 610. Still further, a hypervisor 618 may be stored in a memory element in the physical memory 612 and be executed by one or more of the physical processors 610. Presence of the operating system 616 may be optional such as in a case where the hypervisor 618 is a Type 1 hypervisor; that is, a bare-metal hypervisor installed directly on the hardware layer 604. In some implementations, the hypervisor 618 may be a Type 2 hypervisor, which executes on a host operating system, such as the OS 616, which may provide virtualization services such as I/O device support and memory management.

Executing on one or more of the physical processors 610 may be one or more virtual machines 620a-c (generally 620). The virtual machines 620 may have respective virtual disks 622a-c and virtual processors 624a-c. In some embodiments, a first virtual machine 620a may execute, using the virtual processor 624a, a control program 626 that includes a tools stack 628. The control program 626 may be referred to as a control virtual machine, Domain 0, Dom0, or other virtual machine used for system administration and/or control. In some embodiments, one or more of the virtual machines 620b-c may execute, using a virtual processor 624b-c, a guest operating system 630a-b (generally 630).

The physical devices 608 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 602. The physical memory 612 in hardware layer 604 may include any type of memory. The physical memory 612 may store data, and in some embodiments may store one or more programs, or set of executable instructions. FIG. 6 illustrates an embodiment where firmware 614 is stored within physical memory 612 of virtualization server 602. Programs or executable instructions stored in physical memory 612 may be executed by the one or more of the processors 610 of the virtualization server 602.

The virtualization server 602 may also include hypervisor 618. In some embodiments, the hypervisor 618 may be a program executed by processors 610 on the virtualization server 602 to create and manage any number of virtual machines 620. The hypervisor 618 may be referred to as a virtual machine monitor, or platform virtualization software. In some embodiments, the hypervisor 618 may be any combination of executable instructions and hardware that monitors virtual machines 620 executing on a computing machine. The hypervisor 618 may be a Type 2 hypervisor, where the hypervisor executes within operating system 616 executing on virtualization server 602. The virtual machines may then execute at a layer above hypervisor 618. In some embodiments, the Type 2 hypervisor may execute within the context of a user's operating system such that the Type 2 hypervisor interacts with the user's operating system. In other embodiments, one or more virtualization servers 602 in a virtualization environment may instead include a Type 1 hypervisor (not shown). A Type 1 hypervisor may execute on the virtualization server 602 by directly accessing the hardware and resources within hardware layer 604. That is, while the Type 2 hypervisor 618 accesses system resources through host operating system 616, as shown, a Type 1 hypervisor may directly access all system resources without host operating system 616. A Type 1 hypervisor may execute directly on one or more physical processors 610 of the virtualization server 602, and may include program data stored in the physical memory 612.

The hypervisor 618, in some embodiments, may provide virtual resources to the guest operating systems 630 or control programs 626 executing on virtual machines 620 in any manner that simulates the operating systems 630 or control programs 626 having direct access to system resources. System resources may include, but are not limited to, the physical devices 608, the physical disks 606, the physical processors 610, physical memory 612, and any other component included in the hardware layer 604 of the virtualization server 602. The hypervisor 618 may be used to emulate virtual hardware, partition physical hardware, virtualize physical hardware, and/or execute virtual machines that provide access to computing environments. In still other embodiments, the hypervisor 618 may control processor scheduling and memory partitioning for the virtual machine 620 executing on the virtualization server 602. Examples of hypervisor 618 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. In some embodiments, the virtualization server 602 may execute a hypervisor 618 that creates a virtual machine platform on which the guest operating systems 630 may execute. In these embodiments, the virtualization server 602 may be referred to as a host server. An example of such a virtualization server is Citrix Hypervisor® provided by Citrix Systems, Inc., of Fort Lauderdale, Fla.

The hypervisor 618 may create one or more virtual machines 620b-c (generally 620) in which guest operating systems 630 execute. In some embodiments, the hypervisor 618 may load a virtual machine image to create a virtual machine 620. The virtual machine image may refer to a collection of data, states, instructions, etc. that make up an instance of a virtual machine. In other embodiments, the hypervisor 618 may execute guest operating system 630 within the virtual machine 620. In still other embodiments, the virtual machine 620 may execute the guest operating system 630.

In addition to creating the virtual machines 620, the hypervisor 618 may control the execution of at least one virtual machine 620. In other embodiments, the hypervisor 618 may present at least one virtual machine 620 with an abstraction of at least one hardware resource provided by the virtualization server 602 (e.g., any hardware resource available within hardware layer 604). In other embodiments, the hypervisor 618 may control the manner in which the virtual machines 620 access physical processors 610 available in the virtualization server 602. Controlling access to the physical processors 610 may include determining whether the virtual machine 620 should have access to the processor 610, and how physical processor capabilities are presented to the virtual machine 620.

As shown in FIG. 6, the virtualization server 602 may host or execute one or more virtual machines 620. A virtual machine 620 may be a set of executable instructions and/or user data that, when executed by processor 610, may imitate the operation of a physical computer such that the virtual machine 620 may execute programs and processes much like a physical computing device. While FIG. 6 illustrates an embodiment where the virtualization server 602 hosts three virtual machines 620, in other embodiments the virtualization server 602 may host any number of virtual machines 620. The hypervisor 618, in some embodiments, may provide the virtual machines 620 with unique virtual views of the physical hardware, including the memory 612, the processor 610, and other system resources 606, 608 available to the respective virtual machines 620. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, the hypervisor 618 may create one or more unsecure virtual machines 620 and one or more secure virtual machines 620. The unsecure virtual machines 620 may be prevented from accessing resources, hardware, memory locations, and programs that the secure virtual machines 620 may be permitted to access. In other embodiments, the hypervisor 618 may provide the virtual machines 620 with substantially similar virtual views of the physical hardware, memory, processor, and other system resources available to the virtual machines 620.

The virtual machines 620 may include respective virtual disks 622a-c (generally 622) and virtual processors 624a-c (generally 624.) The virtual disk 622, in some embodiments, may be a virtualized view of one or more physical disks 606 of the virtualization server 602, or a portion of one or more physical disks 606 of the virtualization server 602. The virtualized view of the physical disks 606 may be generated, provided, and managed by the hypervisor 618. In some embodiments, the hypervisor 618 may provide the virtual machines 620 with unique views of the physical disks 606. Thus, in these embodiments, a particular virtual disk 622 included in a respective virtual machine 620 may be unique when compared with other virtual disks 622.

The virtual processor 624 may be a virtualized view of one or more physical processors 610 of the virtualization server 602. In some embodiments, the virtualized view of physical processors 610 may be generated, provided, and managed by the hypervisor 618. In some embodiments, the virtual processor 624 may have substantially all of the same characteristics of at least one physical processor 610. In other embodiments, the virtual processor 610 may provide a modified view of the physical processors 610 such that at least some of the characteristics of the virtual processor 624 are different from the characteristics of the corresponding physical processor 610.

### G. Detailed Description of Example Embodiments of a System for Providing an Improved User Interface for a Delivered Virtual Desktop

An example implementation of a system 100 for providing an improved user interface for a delivered virtual desktop was introduced above (in Section A) in connection with FIGS. 1A-D. As Section A describes, the system 100 may enable a mobile device 102 to provide UI functionality for a remote computing environment that supplements the UI of the delivered virtual desktop for that environment, thus improving the user experience with respect to the delivered virtual desktop. In particular, as noted, the mobile device 102 may be utilized, for example, to allow a user (1) to select a particular application to be used within the delivered virtual desktop (e.g., as shown in FIG. 1B), (2) to select a particular file to be opened on the virtual desktop (e.g., as shown in FIG. 1C), and/or (3) to receive and manage notifications generated by applications executing in the remote computing environment that is being delivered to the mobile device 102 and presented via the virtual desktop (e.g., as shown in FIG. 1D).

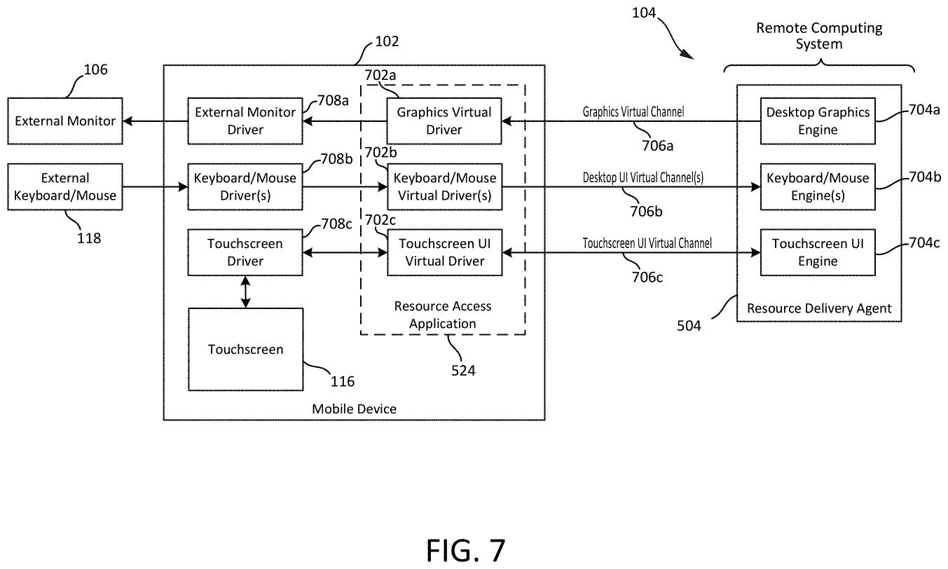

FIG. 7 shows example components of the mobile device 102 and the remote computing system 104 (shown in FIG. 1A) that may be employed to enable such supplemental UI functionality by the touchscreen 116 of the mobile device 102 in accordance with some embodiments. As shown in FIG. 7, the mobile device 102 may include a resource access application 524 that communicates with a resource delivery agent 504 to deliver a virtual desktop for a remote computing environment to the mobile device 102, such as described above in connection with FIGS. 5A-F. As indicated by arrows 706a-c, a number of virtual channels may be established between the resource access application 524 and the resource delivery agent 504, with individual virtual channels comprising software engines 704 (included in the resource delivery agent 504) that communicate with corresponding virtual drivers 702 (included in the resource access application 524). As shown, the virtual drivers 702 may interface with corresponding physical device drivers 708 for respective hardware devices. In particular, in the illustrated example, a graphics virtual driver 702a interfaces with an external monitor driver 708a for the external monitor 106, one or more keyboard/mouse virtual drivers 702b interface with corresponding keyboard/mouse driver(s) 708b for an external keyboard 118a and/or external mouse 118b, and a touchscreen UI virtual driver 702c interfaces with a touchscreen driver 708c for the built-in touchscreen 116 of the mobile device 102.

As indicated by the arrow 706a in FIG. 7, in one direction, the desktop graphics engine 704a of the resource delivery agent 504 may send data (e.g., graphics data) for the virtual desktop that is to be displayed on the external monitor(s) 106 via a “graphics virtual channel.” In the other direction, as indicated by the arrow 706b, input to the external keyboard 118a and/or external mouse 118b may be sent to one or more keyboard/mouse engine(s) 704b of the resource delivery agent 504 via one or more “desktop UI virtual channels.” Accordingly, by way of the desktop UI virtual channel(s) and the graphics virtual channel, respectively, a user may operate the external keyboard 118a and/or external mouse 118b (or other UI device(s)) to provide inputs to the remote computing environment that is being delivered to the mobile device 102, and may view the virtual desktop for that computing environment via the external monitor(s) 106. It should be appreciated that, in some implementations, other external and/or built-in UI devices may additionally or alternatively be used to provide input to the virtual computing environment similar to that provided by the external keyboard/mouse 118 shown in FIG. 7. For instance, in some implementations, a portion of the touchscreen 116 and/or another mobile device may be used to provide keyboard input to and/or enable trackpad functionality for the remote computing environment that is being delivered to the mobile device 102.

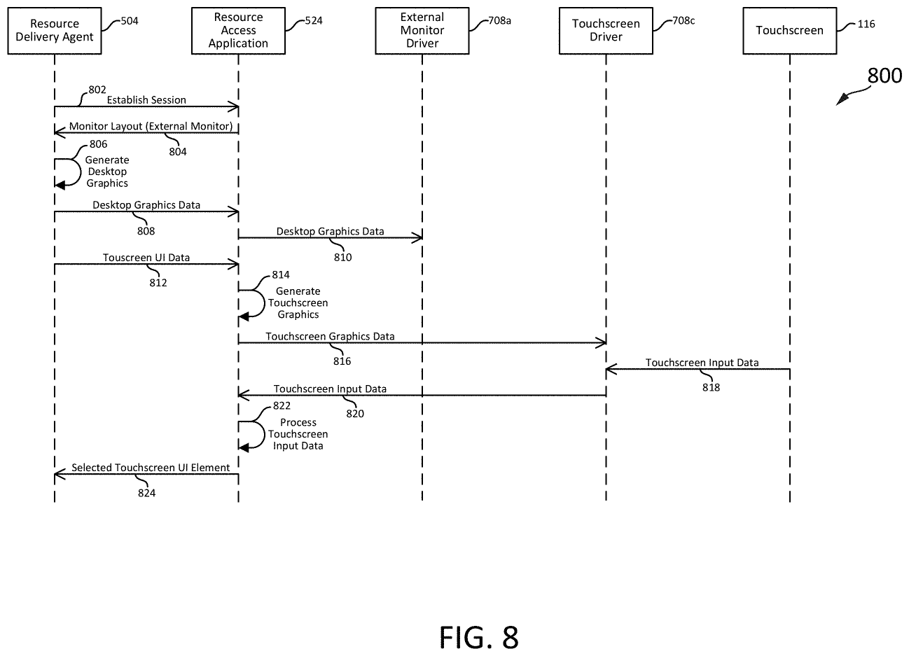

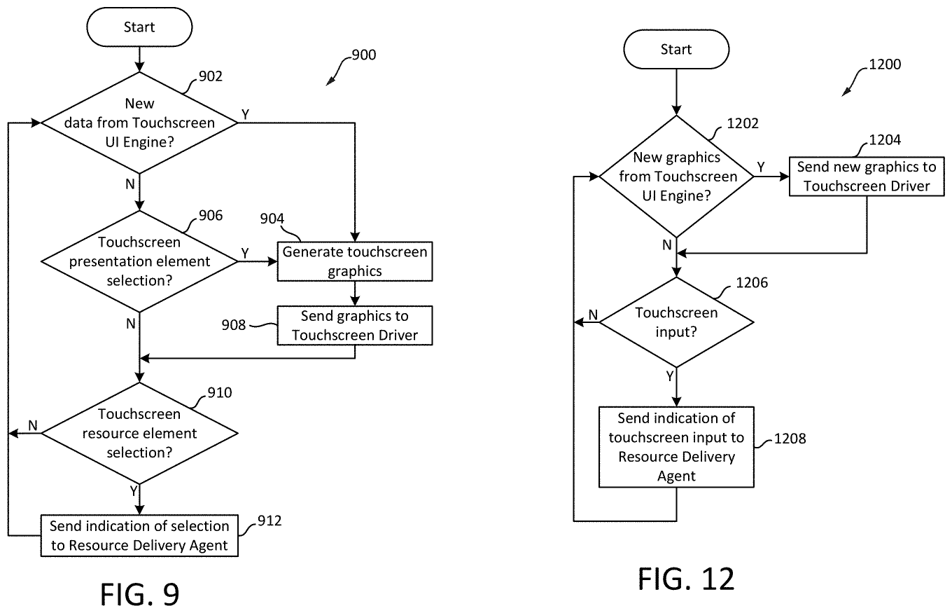

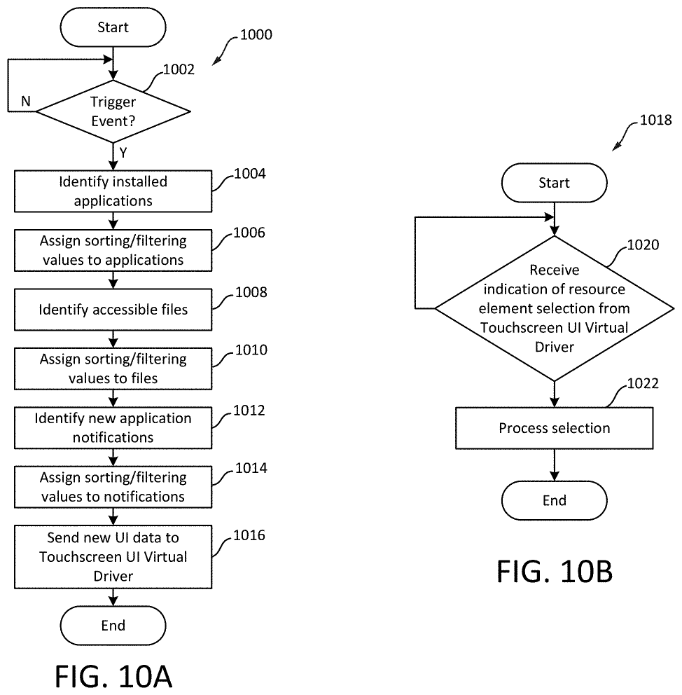

In some implementations, the touchscreen UI engine 704c and the touchscreen UI virtual driver 702c may operate together to enable the use of the touchscreen 116 for supplemental UI features, such as those described above in connection with FIGS. 1B-D. As indicated by an arrow 706c in FIG. 7, those two components may establish a “touchscreen UI virtual channel” via which data relating to such additional UI functionality may be communicated from the resource delivery agent 504 to the resource access application 524, and vice versa. In some implementations, the UI data that is communicated from the touchscreen UI engine 704c to the touchscreen UI virtual driver 702c may include data that describes applications, files, notifications, etc., and the touchscreen UI virtual driver 702c may be responsible for processing that UI data to generate data (e.g., graphics data) to send to the touchscreen driver 708c for display by the touchscreen 116. In such implementations, the UI data that is communicated from the touchscreen UI virtual driver 702c to the touchscreen UI engine 704c may simply identify particular applications, files, and/or notifications that have been selected via the touchscreen 116. FIG. 8 (described below) shows an example sequence diagram 800 illustrating messages that may be communicated amongst various components of the system 100 in such implementations. Example routines that may be performed by the touchscreen UI virtual driver 702c and the touchscreen UI engine 704c in such implementations are described below in connection with FIGS. 9 and 10, respectively.

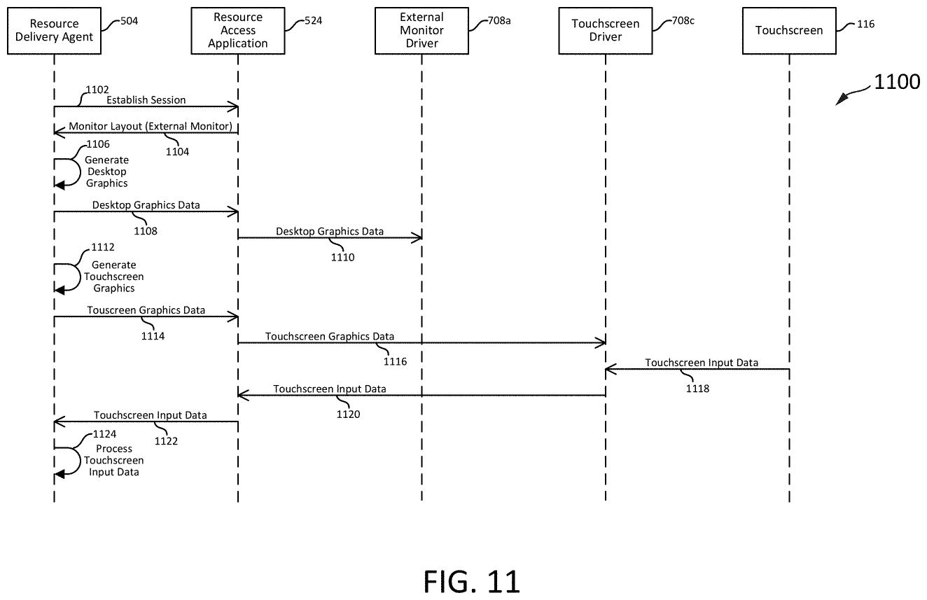

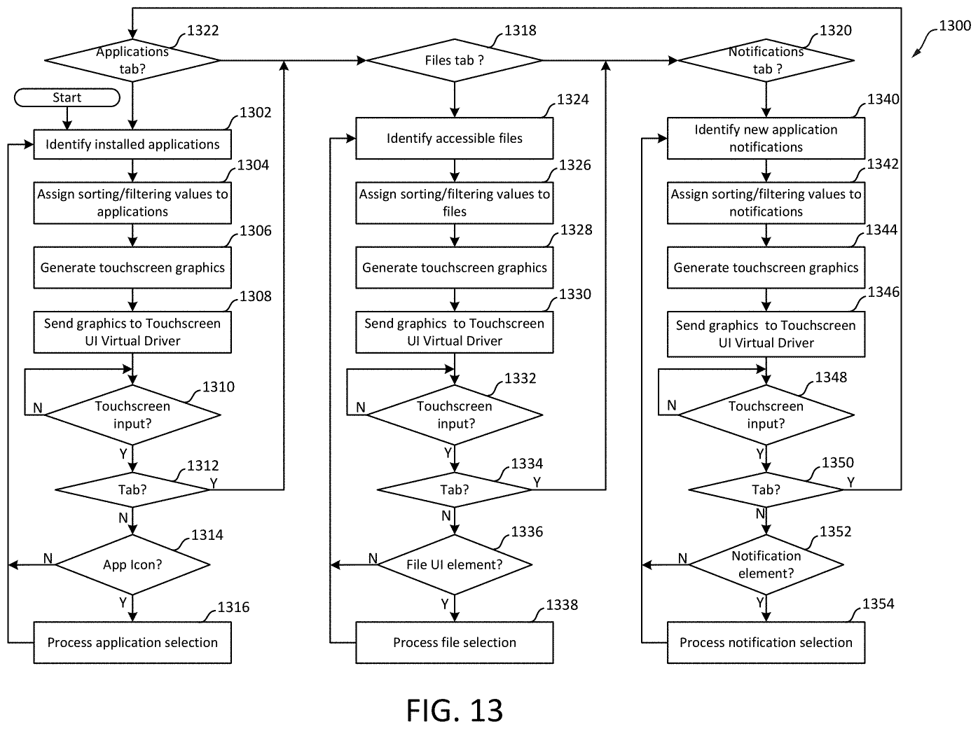

In other implementations, the touchscreen UI engine 704c may itself generate data (e.g., graphics data) that is to be sent to the touchscreen driver 708c for display by the touchscreen 116, and may send that data to the touchscreen UI virtual driver 702c. In such implementations, the UI data that is communicated from the touchscreen UI virtual driver 702c to the touchscreen UI engine 704c may represent touch inputs that are detected by the touchscreen 116, and the touchscreen UI engine may be responsible for correlating those touch inputs with the graphics being displayed on the touchscreen 116 to determine intended user inputs. FIG. 11 (described below) shows an example sequence diagram illustrating messages that may be communicated amongst various components of the system 100 in such implementations. Example routines that may be performed by the touchscreen UI virtual driver 702c and the touchscreen UI engine 704c in that alternative implementation are described below in connection with FIGS. 12 and 13, respectively.

As noted above, the sequence diagram 800 shown in FIG. 8 illustrates messages that may be exchanged in an example implementation of the system 100 in which a component of the resource access application 524 (e.g., the touchscreen UI virtual driver 702c) is responsible for generating data (e.g., graphics data) for display by the touchscreen 116, and for translating inputs to the touchscreen 116 into commands for the resource delivery agent 504. As shown in FIG. 8, the resource delivery agent 504 may establish (802) a session (e.g., an Independent Computing Architecture (ICA) ICA session) with the resource access application 524. An example process for establishing such a session is described above (in Section E) in connection with FIGS. 5A-F. In some implementations, establishing the session may involve the creation of the various virtual channels discussed above in connection with FIG. 7.

The resource access application 524 may send (804) a message to the resource delivery agent 504 indicating the number and type(s) of monitors that are to be used to display the virtual desktop for viewing by a user operating the mobile device 102. In some implementations, for example, available monitors may be detected by the resource access application 524 (e.g., by requesting such data from an operating system of the mobile device 102), and the message sent to the resource delivery agent 504 may identify such monitor(s). In some implementations, the resource access application 524 may additionally or alternatively provide a user interface to enable the user of the mobile device 102 to specify the monitors that are to be used to display the virtual desktop. As indicated, that message may indicate that one or more external monitors 106 are to be employed. Based on the received message, a component of the resource delivery agent 504 may generate (806) graphics for the virtual desktop that are formatted for display by the indicated type(s) of external monitor(s) 106, and the resource delivery agent 504 may send (808) data representing the generated desktop graphics to a component of the resource access application 524. As described above in connection with FIG. 7, for example, in some implementations, such data may be generated by a desktop graphics engine 704a of the resource delivery agent 504 and sent to a graphics virtual driver 702a of the resource access application 524 via a graphics virtual channel (e.g., see the arrow 706a) established between those two components. A component of the resource access application 524 (e.g., the graphics virtual driver 702a) may then send (810) that data to one or more external monitor drivers 708a so as to cause the external monitor(s) 106 to display the virtual desktop within a window 112, such as illustrated in FIG. 1A.

As further shown in FIG. 8, a component of the resource delivery agent 504 may send (812) data relating to the novel touchscreen UI functionality disclosed herein to a component of the resource access application 524. As described above in connection with FIG. 7, for example, in some implementations, such touchscreen UI data may be generated by a touchscreen UI engine 704c of the resource delivery agent 504 and sent to a touchscreen UI virtual driver 702c of the resource access application 524 via a touchscreen UI virtual channel (e.g., see the arrow 706c) established between those two components. As noted above, the touchscreen UI data in such implementations may, for example, describe a number of applications hosted in the remote computing environment that are accessible to the mobile device 102 via the virtual desktop, a number of files that may be accessed via the virtual desktop, and/or a number of notifications for applications executing on the remote computing environment that is being delivered to the mobile device 102 via the virtual desktop.

Based on the touchscreen UI data received from the resource delivery agent 504, a component of the resource access application 524 (e.g., the touchscreen UI virtual driver 702c) may generate (814) data for an image to be presented by the touchscreen 116. In some implementations, for example, such data may be generated to cause the touchscreen 116 to display additional UI content 122, such as that described above in connection with FIGS. 1B-D. The resource access application 524 may then send (816) the generated data to the touchscreen driver 708c so as to cause the additional UI content 122 to be displayed on the touchscreen 116.

Upon viewing the additional UI content 122 on the touchscreen 116 (e.g., as shown in one of FIGS. 1B-D), the user may provide a touch or other input to the touchscreen 116 corresponding to a displayed item (e.g., an application icon 126 per FIG. 1B, a file UI element 130 per FIG. 1C, or a notification element 134 per FIG. 1D), and the touchscreen driver 708c may receive (818) data indicative of that user input from the touchscreen 116. The touchscreen driver 708c may then forward (820) the received data (e.g., touchscreen input data) to a component of the resource access application 524 (e.g., the touchscreen UI virtual driver 702c). The resource access application 524 may then process (822) the received data (e.g., touchscreen input data) to determine which, if any, UI elements displayed on the touchscreen 116 has been selected. If the resource access application 524 determines that a touchscreen UI element corresponding to a managed resource (e.g., an application icon 126, a file UI element 130, or a notification element 134) has been selected, the resource access application 524 may send (824) an indication of the selected UI element to the resource delivery agent 504, thus enabling the resource delivery agent 504 to take a corresponding action with respect to that resource. If the resource access application 524 instead determines that another UI element displayed on the touchscreen 116 (e.g., a tab 124, a folder 128, a checkbox for sorting or filtering, etc.) has been selected, the resource access application 524 may generate (814) new data (e.g., graphics data) for the touchscreen 116 based on that selection, and send (816) that new data to the touchscreen driver 708c for display by the touchscreen 116.

FIG. 9 shows an example routine 900 that may be employed by a component of the resource access application 524 (e.g., by the touchscreen UI virtual driver 702c shown in FIG. 7) in accordance with the implementation described in connection with the sequence diagram 800 shown in FIG. 8. As shown in FIG. 9, the routine 900 may begin at a decision step 902, at which the touchscreen UI virtual driver 702c may determine whether new touchscreen UI data has been received from the touchscreen UI engine 704c, e.g., per the step 812 of the sequence diagram 800 shown in FIG. 8.

When, at the decision step 902, the touchscreen UI virtual driver 702c determines that new touchscreen UI data has been received, the routine 900 may proceed to a step 904, at which the touchscreen UI virtual driver 702c may generate data (e.g., graphics data) corresponding to additional UI content 122 for the touchscreen 116, such as that described above in connection with FIGS. 1B-D. The step 904 may correspond, for example to the step 814 of the sequence diagram 800 shown in FIG. 8. When, on the other hand, the touchscreen UI virtual driver 702c determines (at the decision step 902) that new touchscreen UI data has not been received, the routine 900 may instead proceed to a decision step 906 (described below).

At a step 908 of the routine 900, the touchscreen UI virtual driver 702c may send the generated data (e.g., graphics data) to the touchscreen driver 708c, so as to cause the touchscreen 116 to display the additional UI content 122. The step 908 may correspond, for example to the step 816 of the sequence diagram 800 shown in FIG. 8.

Following the step 908, the routine 900 may proceed to a decision step 910, at which the touchscreen UI virtual driver 702c may determine whether a touchscreen UI element corresponding to a managed resource (e.g., an application icon 126, a file UI element 130, or a notification element 134) has been selected. Such a determination may be made for example based on data (e.g., touchscreen input data) received from the touchscreen driver 708c, e.g., per the step 820 of the sequence diagram 800 shown in FIG. 8. When, at the decision step 910, the touchscreen UI virtual driver 702c determines that such a resource-related element has been selected, the routine 900 may proceed to a step 912, at which the touchscreen UI virtual driver 702c may send an indication of the selected element to the resource delivery agent 504 (e.g., per the step 824 of the sequence diagram 800 shown in FIG. 8) for processing to take a corresponding action with respect to the remote computing environment being delivered the mobile device 102, as described above. When, on the other hand, the touchscreen UI virtual driver 702c determines (at the decision step 910) that such a resource-related element has not been selected, the routine 900 may instead return to the decision step 902, at which the touchscreen UI virtual driver 702c may again determine whether new touchscreen UI data has been received from the touchscreen UI engine 704c.

Although not illustrated in FIG. 9, in some implementations, in response to determining (at the decision step 910) that a resource-related element has been selected, the routine 900 may alternatively proceed to the step 904, at which the touchscreen UI virtual driver 702c may generate new data (e.g., graphics data) for the touchscreen 116. For example, when a notification element 134 (shown in FIG. 1D) has been selected, the touchscreen UI virtual driver 702c may generate new data (e.g., graphics data) that alters the state of an indicator 138 for the selected notification element 134 (e.g., to change it from green to red).

At the decision step 906, the touchscreen UI virtual driver 702c may determine whether a touchscreen UI element impacting the presentation of the additional UI content 122 (e.g., a tab 124, a folder 128, a checkbox for sorting or filtering, etc.) has been selected. The identify of selected touchscreen UI elements may be determined, for example, by comparing the coordinates on the touchscreen 116 where touches occur to the coordinates on the touchscreen 116 at which the touchscreen UI elements are displayed. When, at the decision step 906, the touchscreen UI virtual driver 702c determines that such a presentation-related UI element has been selected, the routine 900 may proceed to the step 904 (described above), at which new graphics for the additional UI content 122 may be generated to reflect the new presentation option. When, on the other hand, the touchscreen UI virtual driver 702c determines that such a presentation-related UI element has not been selected, the routine 900 may instead proceed to the decision step 910 (described above).

FIG. 10A shows a first example routine 1000 that may be employed by a component of the resource delivery agent 504 (e.g., by the touchscreen UI engine 704c shown in FIG. 7) in accordance with the implementation described in connection with the sequence diagram 800 shown in FIG. 8. As shown in FIG. 10A, the routine 1000 may begin when, at a decision step 1002, the touchscreen UI engine 704c determines, using one of the techniques described below, that a trigger event for sending updated touchscreen UI data to the touchscreen UI virtual driver 702c has occurred. Any of a number of trigger events may be detected per the decision step 1002. In some implementations, a trigger event may include the elapsing of a regular time interval, such as every “30” seconds. In other implementations, a trigger event may additionally or alternatively include receipt or detection of a particular type of data, such as an indication that a managed application has generated a new notification, an indication that a new application has been installed on the remote computing environment or the like, and/or an indication that a new file has been created or otherwise become accessible via the virtual desktop. In some implementations, different types of triggering events may cause the touchscreen UI engine 704c to perform only a certain subset of the subsequent steps shown in FIG. 10 that relate to the trigger event in question.

At a step 1004 of the routine 1000, the touchscreen UI engine 704c may identify the applications that have been installed in the remote computing environment being delivered to the mobile device 102, and that can thus be selectively accessed via the virtual desktop being displayed on the external monitor(s) 106. In some implementations, such applications may be identified by querying a registry of an operating system of the remote computing environment. For example, if the remote computing system is running a Microsoft Windows operating system, application names, paths, executable hashes, etc., for the to-be-listed applications may be generated and/or updated by searching the registry key “HKEY_LOCAL_MACHINE\SOFTWARE\Microsoft\Windows\CurrentVersion\Uninstall.” In some implementations, the identity of accessible applications may additionally or alternatively be determined by monitoring Windows processing launching events.

At a step 1006 of the routine 1000, the touchscreen UI engine 704c may assign and/or adjust values (to be used for sorting and/or filtering) to the applications that were identified at the step 1004. In some implementations, for example, applications may be assigned values indicating the frequency at which they have historically been accessed via the virtual desktop. Additionally or alternatively, applications may be assigned values indicating when they were last accessed. Such values may be used, for example, to determine whether and/or in what order indicators of applications are to appear when rendered on the touchscreen 116. For example, with reference to FIG. 1B, applications icons 126 for more frequently and/or more recently accessed applications may be rendered higher on the touchscreen 116 than less frequently and/or less recently accessed applications, thus making it easier for a user to locate the applications icons 126 the user is mostly likely interested in selecting. In some implementations, the occasions on which particular applications are accessed may be tracked by monitoring Windows process launching events, and values may be calculated and assigned to respective applications based on accumulated data concerning such events. In some implementations, the list of applications indicated in the touchscreen UI data sent to the resource access application 524 may be limited, and those applications that are the least frequently accessed and/or were accessed least recently may be omitted from that data. In other implementations, the data (e.g., touchscreen UI data) sent to the resource access application 524 may identify all of the installed applications, with the expectation that the resource access application 524 will use the assigned values to determine whether and in what order to present the application icons 126 on the touchscreen 116.

Further, it should be appreciated that, in some implementations, sorting/filtering values need not be assigned to applications, and the resource access application 524 may instead be configured to allow the user of the mobile device 102 to select and move the application icons 126 to different locations on the touchscreen 116, to nest such icons within one or more folders 128, etc., similar to the manner in which users commonly manipulate icons for mobile applications on smartphones and tablets.

At a step 1008 of the routine 1000, the touchscreen UI engine 704c may identify the files that can be accessed by the remote computing environment being delivered to the mobile device 102, and that can thus be selectively accessed via the virtual desktop being displayed on the external monitor(s) 106. In some implementations, such files may be identified by reading registry keys for the applications identified at the step 1004 that are used to access files, e.g., MS Word, PowerPoint, Adobe, etc. As one example, recently opened files for Microsoft Office applications may, in some implementations, be identified by querying the registry key(s) at the path “C:\Users\AppData\Roaming\Microsoft\Office\Recent.”

At a step 1010 of the routine 1000, the touchscreen UI engine 704c may assign and/or adjust values (to be used for sorting and/or filtering) to the files that were identified at the step 1008. In some implementations, for example, files may be assigned values indicating the frequency at which they have historically been accessed via the virtual desktop. Additionally or alternatively, files may be assigned values indicating when they were last accessed, when they were last modified, when they were created, their name, their size, etc. Such values may be used, for example, to determine how to sort and/or filter the file UI elements 130 displayed on the touchscreen 116. As was described above in connection with FIG. 1C, in some implementations, selectable options 132 may be presented on the touchscreen 116 to allow a user to determine whether and/or in what order the file UI elements 130 are to be presented. The sorting/filtering values assigned at the step 1010 may be used to facilitate such sorting and/or filtering based on the selectable options 132 the user has selected. In other implementations, the criteria for sorting and/or filtering the file UI elements 130 may be fixed, e.g., by always filtering and/or sorting the file UI elements 130 using a particular process optimized to bring icons for the files the user is mostly likely to want to access to the top of the list, such as by using a weighted combination of how frequently and how recently the files identified at the step 1008 have been accessed.

At a step 1012 of the routine 1000, the touchscreen UI engine 704c may identify notifications concerning events of some or all of applications identified at the step 1004. In some implementations, the manner in which such notifications are identified may depend on the types of applications that are being monitored. For some application types, an application programming interface (API) hooking technique may be used to identify new notifications. For instance, for certain applications, message notification APIs for those applications may be identified and used by the touchscreen UI engine 704c to set a hook for new notification messages. As one example, for MS Teams, a Citrix Metaframe API Hook (MFAHook), i.e., a Dynamic Link Library (DLL) process enabling Asynchronous Procedure Call (APC) API hooking, may be used to inspect notifications of an MS Teams application that is executing in the remote computing environment being delivered to the mobile device 102, and to identify notifications of that application that are to be sent to the touchscreen UI virtual driver 702c of the resources access application 524 on the mobile device 102 for presentation on the touchscreen 116, e.g., as one of the notification elements 134 shown in FIG. 1D.

For applications for which a plug-in mechanism is provided, a plugin may additionally or alternatively be installed in the application to detect and/or generate new notifications about the application's events. As one example, for MS Outlook, an outlook plugin may be installed to inspect newly-received emails and redirect notifications for such emails, or to generate and send new notifications concerning such emails, to the touchscreen UI engine 704c.

At a step 1014 of the routine 1000, the touchscreen UI engine 704c may assign and/or adjust values (to be used for sorting and/or filtering) to the notifications that were identified at the step 1012. In some implementations, for example, notifications may be assigned values indicating when they were created, whether they have been read by the user, the application to which they relate, the sender of a message to which the notification relates, etc. Such values may be used, for example, to determine how to sort and/or filter the notifications elements 134 displayed on the touchscreen 116. As was described above in connection with FIG. 1D, in some implementations, selectable options 136 may be presented on the touchscreen 116 to allow a user to determine whether and/or in what order the notification elements 134 are to be presented. The sorting/filtering values assigned at the step 1014 may be used to facilitate sorting and/or filtering based on the selectable options 136 the user has selected. In other implementations, the criteria for sorting and/or filtering the notification elements may be fixed, e.g., by always filtering and/or sorting the notification elements 134 so as cause the touchscreen 116 to display only the most recent, unread notifications.

At a step 1016, of the routine 1000, touchscreen UI engine 704c may send the data accumulated at the steps 1004, 1006, 1008, 1010, 1012, and 1014 to the touchscreen UI virtual driver 702c for use in presenting additional UI content 122 on the touchscreen 116, such as illustrated in FIGS. 1B-C.

FIG. 10B shows a second example routine 1018 that may be employed by a component of the resource delivery agent 504 (e.g., by the touchscreen UI engine 704c shown in FIG. 7) in accordance with the implementation described in connection with FIG. 8. As shown in FIG. 10B, the routine 1018 may begin at a decision step 1020, when the touchscreen UI engine 704c determines that it has received a message from a component of the resource access application 524 (e.g., the touchscreen UI virtual driver 702c) indicating that a resource-related element of the additional UI content 122 (e.g., an application icon 126, a file UI element 130, or a notification element 134) has been selected via the touchscreen 116. Such message may have been sent, for example, by the touchscreen UI virtual driver 702c pursuant to the step 912 of the routine 900 shown in FIG. 9.

At a step 1022 of the routine 1018, the touchscreen UI engine 704c may process the indicated selection. The step 1022 may correspond, for example to the step 822 of the sequence diagram 800 shown in FIG. 8. With reference to FIG. 1B, in some implementations, in response to receiving an indication that an application icon 126 on the touchscreen 116 has been selected, if the corresponding application has not yet been launched on the remote computing system 104, the touchscreen UI engine 704c may cause the application to be launched and presented within a new window of the virtual desktop that is being delivered to the mobile device 102 and displayed on the external monitor(s) 106. For example, in some implementations, the selected application may be launched on a shared computing resource 502 (described in Section E) that is hosting the virtual desktop being delivered to the mobile device 102. If, on the other hand, the application corresponding to a selected application icon 126 has already been launched on the remote computing system 104, the touchscreen UI engine 704c may instead cause an existing window for that application to be un-minimized, maximized, and/or brought to the foreground of the virtual desktop that is being delivered to the mobile device 102 and displayed on the external monitor(s) 106. Such control of the window for the selected resource may be accomplished, for example, by sending an appropriate instruction to a component of the resource delivery agent 504 (e.g., the desktop graphics engine 704c) that is overseeing delivery of the content for virtual desktop to the mobile device 102.

Further, with reference to FIG. 1C, in some implementations, in response to receiving an indication that a file UI element 130 on the touchscreen 116 has been selected, if the application needed to access the corresponding file has not yet been launched on the remote computing system 104, the touchscreen UI engine 704c may cause the application to be launched and used to open the selected file within a new window of the virtual desktop that is being delivered to the mobile device 102 and displayed on the external monitor(s) 106. For example, in some implementations, the requisite application may be launched on a shared computing resource 502 (described in Section E) that is hosting the virtual desktop being delivered to the mobile device 102. If, on the other hand, the application needed to open the selected file has already been launched on the remote computing system 104, the touchscreen UI engine 704c may instead simply cause the file to be opened within a new window for that application within the delivered virtual desktop. In some implementations, for example, a component of the resource delivery agent 504 (e.g., the desktop graphics engine 704a) that is overseeing delivery of the content for virtual desktop to the mobile device 102 may be instructed to open the selected file within a new window. Accordingly, this technique may greatly facilitate a user's ability to quickly access a desired file within the virtual desktop.

And still further, with reference to FIG. 1D, in some implementations, in response to receiving an indication that a notification element 134 on the touchscreen 116 has been selected, the touchscreen UI engine 704c may cause a window for the application responsible for the notification to be opened and/or brought to the foreground within the virtual desktop that is being delivered to the mobile device 102 and displayed on the external monitor(s) 106. For instance, if a selected notification element 134 was generated based on a new message received by a messaging application, the window for that messaging application may be brought to the foreground of the virtual desktop and/or or the newly-received message may be opened in a new window on the virtual desktop. Such control of a window for an application responsible for a selected notification may be accomplished, for example, by sending an appropriate instruction to a component of the resource delivery agent 504 (e.g., the desktop graphics engine 704a) that is overseeing delivery of the content for virtual desktop to the mobile device 102.

As noted above, the sequence diagram 1100 shown in FIG. 11 illustrates messages that may be exchanged in an example implementation of the system 100 in which a component of the resource delivery agent 504 (e.g., the touchscreen UI engine 704c) is responsible for generating data (e.g., graphics data) for display by the touchscreen 116, and for translating data indicative of touch inputs to the touchscreen 116 into commands. As shown in FIG. 11, the resource delivery agent 504 may establish (1102) a session (e.g., an ICA session) with the resource access application 524. An example process for establishing such a session is described above (in Section E) in connection with FIGS. 5A-F. In some implementations, establishing the session may involve the creation of the various virtual channels discussed above in connection with FIG. 7.

The resource access application 524 may send (1104) a message to the resource delivery agent 504 indicating the number and type(s) of monitors that are to be used to display the virtual desktop for viewing by a user operating the mobile device 102. In some implementations, for example, available monitors may be detected by the resource access application 524 (e.g., by requesting such data from an operating system of the mobile device 102), and the message sent to the resource delivery agent 504 may identify such monitor(s). In some implementations, the resource access application 524 may additionally or alternatively provide a user interface to enable the user of the mobile device 102 to specify the monitors that are to be used to display the virtual desktop. As indicated, the message send to the resource delivery agent 504 may indicate that one or more external monitors 106 are to be employed. Based on the received message, a component of the resource delivery agent 504 may generate (1106) data (e.g., graphics data) for the virtual desktop that are formatted for display by the indicated type(s) of external monitor(s) 106, and the resource delivery agent 504 may send (1108) data representing the generated desktop graphics to a component of the resource access application 524. As described above in connection with FIG. 7, for example, in some implementations, such data (e.g., e.g., desktop graphics data) may be generated by a desktop graphics engine 704a of the resource delivery agent 504 and sent to a graphics virtual driver 702a of the resource access application via a graphics virtual channel (e.g., see the arrow 706a) established between those two components. A component of the resource access application 524 (e.g., the graphics virtual driver 702a) may then send (1110) that data to one or more external monitor drivers 708a so as to cause the external monitor(s) 106 to display the virtual desktop within a window 112, such as illustrated in FIG. 1A.

As further shown in FIG. 8, a component of the resource delivery agent 504 (e.g., the touchscreen UI engine 704c) may generate (1112) data (e.g., graphics data) for an image to be presented by the touchscreen 116. In some implementations, for example, such data may be generated to cause the touchscreen 116 to display additional UI content 122, such as that described above in connection with FIGS. 1B-D. The resource delivery agent 504 may then send (1114) the generated data to a component of the resource access application 524 (e.g., the touchscreen UI virtual driver 702c), and the resource access application 524 may, in turn, send (1116) that data to the touchscreen driver 708c so as to cause the additional UI content 122 to be displayed on the touchscreen 116.

Upon viewing the additional UI content 122 on the touchscreen 116 (e.g., as shown in one of FIGS. 1B-D), the user may provide a touch input to the touchscreen 116 corresponding to a displayed item (e.g., an application icon 126 per FIG. 1B, a file UI element 130 per FIG. 1C, or a notification element 134 per FIG. 1D), and the touchscreen driver 708c may receive (1118) data indicative of that user input from the touchscreen 116. The touchscreen driver 708c may then forward (1120) the received data (e.g., touchscreen input data) to a component of the resource access application 524 (e.g., the touchscreen UI virtual driver 702c), and the resource access application 524 may, in turn, send (1122) that data to a component of the resource delivery agent 504 (e.g., the touchscreen UI engine 704c). The touchscreen UI engine 704c may then process (1124) the received data to determine which, if any, UI elements displayed on the touchscreen 116 has been selected. If the resource delivery agent 504 determines that a touchscreen UI element corresponding to a managed resource (e.g., an application icon 126, a file UI element 130, or a notification element 134) has been selected, the resource delivery agent 504 may take a corresponding action with respect to that resource. If the resource delivery agent 504 instead determines that another UI element displayed on the touchscreen 116 (e.g., a tab 124, a folder 128, a checkbox for sorting or filtering, etc.) has been selected, the resource delivery agent 504 may generate (1112) new data (e.g., graphics data) for the touchscreen 116 based on that selection, and send (1114) that new data (e.g., graphics data) to a component of the resource access application 524 (e.g., the touchscreen UI virtual driver 702c), which may, in turn, send (1116) the data to the touchscreen driver 708c for display by the touchscreen 116.

FIG. 12 shows an example routine 1200 that may be employed by a component of the resource access application 524 (e.g., by the touchscreen UI virtual driver 702c shown in FIG. 7) in accordance with the implementation described in connection with the sequence diagram 1100 shown in FIG. 11. As shown in FIG. 12, the routine 1200 may begin at a decision step 1202, at which the touchscreen UI virtual driver 702c may determine whether new data (e.g., graphics data) for the touchscreen 116 has been received from a component of the resource delivery agent 504 (e.g., the touchscreen UI engine 704c). When, at the decision step 1202, the touchscreen UI virtual driver 702c determines that data (e.g., touchscreen graphics data) has been received, the routine 1200 may proceed to a step 1204, at which the touchscreen UI virtual driver 702c may send the received data to the touchscreen driver 708c, so as to cause the touchscreen 116 to display additional UI content 122 (e.g., graphics representing selectable UI elements) represented by the received data, such as the various selectable UI elements described above in connection with FIGS. 1B-D. When, on the other hand, the touchscreen UI virtual driver 702c determines (at the decision step 1202) that data (e.g., touchscreen graphics data) has not been received, the routine 1200 may instead proceed to a decision step 1206, at which the touchscreen UI virtual driver 702c may determine whether a touch input has been provided to the touchscreen 116.

When, at the decision step 1206, the touchscreen UI virtual driver 702c determines that an input to the touchscreen 116 has been detected, the routine 1200 may proceed to a step 1208, at which the touchscreen UI virtual driver 702c may send an indication of the detected touchscreen input to a component of the resource delivery agent 504 (e.g., the touchscreen UI engine 704c) for processing. When, on the other hand, the touchscreen UI virtual driver 702c determines (at the decision step 1206) that a touchscreen input has not occurred, the routine 1200 may instead return to the decision step 1202, at which the touchscreen UI virtual driver 702c may again determine whether new data for the touchscreen 116 has been received from a component of the resource delivery agent 504 (e.g., the touchscreen UI engine 704c).

FIG. 13 shows an example routine 1300 that may be employed by a component of the resource delivery agent 504 (e.g., by the touchscreen UI engine 704c shown in FIG. 7) in accordance with the implementation described in connection with the sequence diagram 1100 shown in FIG. 11. As shown in FIG. 13, the routine 1300 may begin at a step 1302, at which the touchscreen UI engine 704c may identify the applications that have been installed in the remote computing environment being delivered to the mobile device 102, and that can thus be selectively accessed via the virtual desktop being displayed on the external monitor(s) 106. The manner in which the touchscreen UI engine 704 may go about identifying such applications in some implementations is described above in connection with the step 1004 of the routine 1000 shown in FIG. 10A.

At a step 1304 of the routine 1300, the touchscreen UI engine 704c may assign and/or adjust values (to be used for sorting and/or filtering) to the applications that were identified at the step 1302. The manner in which the touchscreen UI engine 704 may go about assigning/adjust such values in some implementations is described above in connection with the step 1006 of the routine 1000 shown in FIG. 10A.

At a step 1306 of the routine 1300, the touchscreen UI engine 704c may generate data (e.g., graphics data) corresponding to additional UI content 122a for the touchscreen 116, such as that described above in connection with FIG. 1B. The step 1306 may correspond, for example to the step 1112 of the sequence diagram 1100 shown in FIG. 11. The manner in which the touchscreen UI engine 704 may go about generating such data in some implementations is described above in connection with the step 904 of the routine 900 shown in FIG. 9.

At a step 1308 of the routine 1300, the touchscreen UI engine 704c may send the generated data (e.g., touchscreen graphics data) to a component of the resource access application 524 (e.g., the touchscreen UI virtual driver 702c). The step 1308 may correspond, for example to the step 1114 of the sequence diagram 1100 shown in FIG. 11.

At a decision step 1310 of the routine 1300, the touchscreen UI engine 704c may await receipt of data (e.g., touchscreen input data) from a component of the resource access application 524 (e.g., the touchscreen UI virtual driver 702c). As discussed above in connection with the steps 1120 and 1122 of the sequence diagram 1100 shown in FIG. 11, in some implementations, the touchscreen UI virtual driver 702c may receive data (e.g., touchscreen input data) from the touchscreen driver 708c and then forward that data to the touchscreen UI engine 704c. In response to receiving such data (per the decision step 1310), the routine 1300 may proceed to decision steps 1312 and 1314, at which the touchscreen UI engine 704c may determine whether the received data indicates that either a tab 124 or an application icon 126 (see FIG. 1B) has been selected on the touchscreen 116.

When, at the decision step 1312, the touchscreen UI engine 704c determines that a tab 124 has been selected, the routine 1300 may proceed to decisions steps 1318, 1320, and 1322 to determine which tab 124 (e.g., the files tab 124b, the notifications tab 124c, or the applications tab 124a) was selected, and may then proceed as indicated to switch to or “refresh” the data for that tab and await further touchscreen inputs (per decisions step 1332 and 1348, or 1310).

When, at the decision step 1314, the touchscreen UI engine 704c determines that an application icon 126 has been selected, the routine 1300 may proceed a step 1316 at which the touchscreen UI engine 704c may take an appropriate action with respect to the corresponding application. In some implementations, if the corresponding application has not yet been launched on the remote computing system 104, the touchscreen UI engine 704c may cause the application to be launched and presented within a new window of the virtual desktop that is being delivered to the mobile device 102 and displayed on the external monitor(s) 106. If, on the other hand, the application corresponding to a selected application icon 126 has already been launched on the remote computing system 104, the touchscreen UI engine 704c may instead cause an existing window for that application to be un-minimized, maximized, and/or brought to the foreground of the virtual desktop that is being delivered to the mobile device 102 and displayed on the external monitor(s) 106.

When, pursuant to the decisions steps 1312 and 1314, the touchscreen UI engine 704c determines that the touchscreen UI input did not identify a tab 124 or an application icon 126, the routine 1300 may return to the step 1302, at which the data for the additional UI content 122a may be refreshed. When the data (detected per the decision step 1310) indicates that a new sorting/filtering option has been selected, that “refreshing” process may involve generating new data (e.g., graphics data) for the touchscreen 116 (at the step 1306) in accordance with that selection.

At a step 1324 of the routine 1300, the touchscreen UI engine 704c may identify the files that can be accessed by the remote computing environment being delivered to the mobile device 102, and that can thus be selectively accessed via the virtual desktop being displayed on the external monitor(s) 106. The manner in which the touchscreen UI engine 704 may go about identifying such files in some implementations is described above in connection with the step 1008 of the routine 1000 shown in FIG. 10A.

At a step 1326 of the routine 1300, the touchscreen UI engine 704c may assign and/or adjust values (to be used for sorting and/or filtering) to the files that were identified at the step 1324. The manner in which the touchscreen UI engine 704 may go about assigning/adjust such values in some implementations is described above in connection with the step 1010 of the routine 1000 shown in FIG. 10A.

At a step 1328 of the routine 1300, the touchscreen UI engine 704c may generate data (e.g., graphics data) corresponding to additional UI content 122b for the touchscreen 116, such as that described above in connection with FIG. 1C. The step 1328 may correspond, for example to the step 1112 of the sequence diagram 1100 shown in FIG. 11. The manner in which the touchscreen UI engine 704 may go about generating such data in some implementations is described above in connection with the step 904 of the routine 900 shown in FIG. 9.

At a step 1330 of the routine 1300, the touchscreen UI engine 704c may send the generated data (e.g., touchscreen graphics data) to a component of the resource access application 524 (e.g., the touchscreen UI virtual driver 702c). The step 1330 may correspond, for example to the step 1114 of the sequence diagram 1100 shown in FIG. 11.

At a decision step 1332 of the routine 1300, the touchscreen UI engine 704c may await receipt of data (e.g., touchscreen input data) from a component of the resource access application 524 (e.g., the touchscreen UI virtual driver 702c). As discussed above in connection with the steps 1120 and 1122 of the sequence diagram 1100 shown in FIG. 11, in some implementations, the touchscreen UI virtual driver 702c may receive such data from the touchscreen driver 708c and then forward that data to the touchscreen UI engine 704c. In response to receiving such data (per the decision step 1332), the routine 1300 may proceed to decision steps 1334 and 1336, at which the touchscreen UI engine 704c may determine whether the received data indicates that either a tab 124 or a file UI element 130 (see FIG. 1C) has been selected on the touchscreen 116.

When, at the decision step 1334, the touchscreen UI engine 704c determines that a tab 124 has been selected, the routine 1300 may proceed to the decisions steps 1320, 1322, and 1318 to determine which tab 124 (e.g., the notifications tab 124c, the applications tab 124a, or the files tab 124b) was selected, and may then proceed as indicated to switch to or “refresh” the data for that tab and await further touchscreen inputs (per decisions step 1348, 1310, or 1332).

When, at the decision step 1336, the touchscreen UI engine 704c determines that a file UI element 130 has been selected, the routine 1300 may proceed a step 1338, at which the touchscreen UI engine 704c may take an appropriate action with respect to the corresponding file. In some implementations, for example, if the application needed to access the corresponding file has not yet been launched on the remote computing system 104, the touchscreen UI engine 704c may cause the application to be launched and used to open the selected file within a new window of the virtual desktop that is being delivered to the mobile device 102 and displayed on the external monitor(s) 106. If, on the other hand, the application needed to open the selected file has already been launched on the remote computing system 104, the touchscreen UI engine 704c may instead simply cause the file to be opened within a new window for that application within the delivered virtual desktop.

When, pursuant to the decisions steps 1334 and 1336, the touchscreen UI engine 704c determines that the touchscreen UI input did not identify a tab 124 or a file UI element 130, the routine 1300 may return to the step 1324, at which the data for the additional UI content 122b may be refreshed. When the data (detected per the decision step 1332) indicates that a new sorting/filtering option has been selected, that “refreshing” process may involve generating new data (e.g., graphics data) for the touchscreen 116 (at the step 1328) in accordance with that selection.

At a step 1340 of the routine 1300, the touchscreen UI engine 704c may identify may identify notifications concerning events of some or all of applications identified at the step 1302. The manner in which the touchscreen UI engine 704 may go about identifying such notifications in some implementations is described above in connection with the step 1012 of the routine 1000 shown in FIG. 10A.

At a step 1342 of the routine 1300, the touchscreen UI engine 704c may assign and/or adjust values (to be used for sorting and/or filtering) to the notifications that were identified at the step 1340. The manner in which the touchscreen UI engine 704 may go about assigning/adjust such values in some implementations is described above in connection with the step 1014 of the routine 1000 shown in FIG. 10A.

At a step 1344 of the routine 1300, the touchscreen UI engine 704c may generate datat (e.g., graphics data) corresponding to additional UI content 122c for the touchscreen 116, such as that described above in connection with FIG. 1D. The step 1344 may correspond, for example to the step 1112 of the sequence diagram 1100 shown in FIG. 11. The manner in which the touchscreen UI engine 704 may go about generating such data in some implementations is described above in connection with the step 904 of the routine 900 shown in FIG. 9.

At a step 1346 of the routine 1300, the touchscreen UI engine 704c may send the generated data (e.g., touchscreen graphics data) to a component of the resource access application 524 (e.g., the touchscreen UI virtual driver 702c). The step 1346 may correspond, for example to the step 1114 of the sequence diagram 1100 shown in FIG. 11.

At a decision step 1348 of the routine 1300, the touchscreen UI engine 704c may await receipt of data (e.g., touchscreen input data) from a component of the resource access application 524 (e.g., the touchscreen UI virtual driver 702c). As discussed above in connection with the steps 1120 and 1122 of the sequence diagram 1100 shown in FIG. 11, in some implementations, the touchscreen UI virtual driver 702c may receive such data from the touchscreen driver 708c and then forward that data to the touchscreen UI engine 704c. In response to receiving such data (per the decision step 1348), the routine 1300 may proceed to decision steps 1350 and 1352, at which the touchscreen UI engine 704c may determine whether the received data indicates that either a tab 124 or a notification element 134 (see FIG. 1D) has been selected on the touchscreen 116.

When, at the decision step 1350, the touchscreen UI engine 704c determines that a tab 124 has been selected, the routine 1300 may proceed to the decisions steps 1322, 1318, and 1320 to determine which tab 124 (e.g., the applications tab 124a, the files tab 124b, or the notifications tab 124c) was selected, and may then proceed as indicated to switch to or “refresh” the data for that tab and await further touchscreen inputs (per decisions step 1310, 1332, or 1348).

When, at the decision step 1352, the touchscreen UI engine 704c determines that a notification element 134 has been selected, the routine 1300 may proceed a step 1354, at which the touchscreen UI engine 704c may take an appropriate action with respect to the corresponding notification. In some implementations, for example, in response to determining that a notification element 134 on the touchscreen 116 has been selected, the touchscreen UI engine 704c may cause a window for the application responsible for the notification to be opened and/or brought to the foreground within the virtual desktop that is being delivered to the mobile device 102 and displayed on the external monitor(s) 106. For instance, if a selected notification element 134 was generated based on a new message received by a messaging application, the window for that messaging application may be brought to the foreground of the virtual desktop and/or or the newly-received message may be opened in a new window on the virtual desktop.

When, pursuant to the decisions steps 1350 and 1352, the touchscreen UI engine 704c determines that the touchscreen UI input did not identify a tab 124 or notification element 134, the routine 1300 may return to the step 1340, at which the data for the additional UI content 122c may be refreshed. When the data (detected per the decision step 1348) indicates that a new sorting/filtering option has been selected, that “refreshing” process may involve generating new data (e.g., graphics data) for the touchscreen 116 (at the step 1344) in accordance with that selection.

H. Example Implementations of Methods, Systems, and Computer-Readable Media in Accordance with the Present Disclosure

The following paragraphs (M1) through (M9) describe examples of methods that may be implemented in accordance with the present disclosure.

(M1) A method may be performed that involves receiving, by a client device and from a remote computing system via a first communications channel, first graphics content for a virtual desktop of a computing environment hosted on the remote computing system and delivered to the client device; sending, from the client device to at least one external monitor, the first graphics content such that at least a portion of the virtual desktop is presented on the at least one external monitor; receiving, by the client device and from the remote computing system via a second communications channel that is different than the first communications channel, first data indicative of at least one characteristic of plurality of resources hosted in the computing environment and accessible via the virtual desktop; and while the virtual desktop is presented on the at least one external monitor, presenting, on a touchscreen of the client device and based at least in part on the first data, second graphics content indicative of the at least one characteristic of the plurality of resources.

(M2) A method may be performed as described in paragraph (M1), and may further involve sending, from the client device to the remote computing system, second data indicative of a first input provided to a portion of the touchscreen on which the second graphics content is displayed, the portion of the touchscreen corresponding to a first resource of the plurality of resources, and the second data causing a first action to be taken with respect to the first resource.

(M3) A method may be performed as described in paragraph (M2), wherein the first action may comprise causing a window corresponding to the first resource to be presented in a foreground of the virtual desktop.

(M4) A method may be performed as described in paragraph (M2) or paragraph (M3), wherein the first action may comprise launching, within the computing environment, an application corresponding to the first resource.

(M5) A method may be performed as described in any of paragraphs (M1) through (M4), and may further involve receiving, by the client device and from an external user interface device, an indication of a second input to the external user interface device; and sending, from the client device to the remote computing system, third data indicative of the second input, the third data causing a second action to be taken with respect to an application that is represented in a foreground window of the virtual desktop.

(M6) A method may be performed as described in any of paragraphs (M1) through (M5), wherein the first data may be indicative of a plurality of applications that are installed within the computing environment and accessible via the virtual desktop; and the second graphics content may include elements that identify respective applications of the plurality of applications, the elements being selectable to cause output of the identified applications to be presented within the virtual desktop.

(M7) A method may be performed as described in any of paragraphs (M1) through (M6), wherein the first data may be indicative of a plurality of files that are accessible to the computing environment; and the second graphics content may include elements that identify respective files of the plurality of files, the elements being selectable to cause content of the identified files to be presented within the virtual desktop.

(M8) A method may be performed as described in any of paragraphs (M1) through (M7), wherein the first data may be indicative of a plurality of notifications of applications executing within the computing environment; and the second graphics content may include elements that identify respective notifications of the plurality of notifications.

(M9) A method may be performed as described in paragraph (M8), wherein the elements may be selectable to cause output of the applications to which the respective notifications correspond to be presented within a window of the virtual desktop.

The following paragraphs (S1) through (S9) describe examples of systems and devices that may be implemented in accordance with the present disclosure.

(S1) A system may include at least one processor, and at least one computer-readable medium encoded with instructions which, when executed by the at least one processor, cause the system to receive, by a client device and from a remote computing system via a first communications channel, first graphics content for a virtual desktop of a computing environment hosted on the remote computing system and delivered to the client device, to send, from the client device to at least one external monitor, the first graphics content such that at least a portion of the virtual desktop is presented on the at least one external monitor, to receive, by the client device and from the remote computing system via a second communications channel that is different than the first communications channel, first data indicative of at least one characteristic of plurality of resources hosted in the computing environment and accessible via the virtual desktop, and while the virtual desktop is presented on the at least one external monitor, to present, on a touchscreen of the client device and based at least in part on the first data, second graphics content indicative of the at least one characteristic of the plurality of resources.

(S2) A system may be configured as described in paragraph (S1), wherein the at least one computer-readable medium may be further encoded with additional instructions which, when executed by the at least one processor, further cause the system to send, from the client device to the remote computing system, second data indicative of a first input provided to a portion of the touchscreen on which the second graphics content is displayed, the portion of the touchscreen corresponding to a first resource of the plurality of resources, and the second data configured to cause a first action to be taken with respect to the first resource.

(S3) A system may be configured as described in paragraph (S2), wherein the first action may comprise causing a window corresponding to the first resource to be presented in a foreground of the virtual desktop.

(S4) A system may be configured as described in paragraph (S2) or paragraph (S3), wherein the first action may comprise launching, within the computing environment, an application corresponding to the first resource.

(S5) A system may be configured as described in any of paragraphs (S1) through (S4), wherein the at least one computer-readable medium may be further encoded with additional instructions which, when executed by the at least one processor, further cause the system to receive, by the client device and from an external user interface device, an indication of a second input to the external user interface device; and to send, from the client device to the remote computing system, third data indicative of the second input, the third data causing a second action to be taken with respect to an application that is represented in a foreground window of the virtual desktop.

(S6) A system may be configured as described in any of paragraphs (S1) through (S5), wherein the first data may be indicative of a plurality of applications that are installed within the computing environment and accessible via the virtual desktop; and the second graphics content may include elements that identify respective applications of the plurality of applications, the elements being selectable to cause output of the identified applications to be presented within the virtual desktop.

(S7) A system may be configured as described in any of paragraphs (S1) through (S6), wherein the first data may be indicative of a plurality of files that are accessible to the computing environment; and the second graphics content may include elements that identify respective files of the plurality of files, the elements being selectable to cause content of the identified files to be presented within the virtual desktop.

(S8) A system may be configured as described in any of paragraphs (S1) through (S7), wherein the first data may be indicative of a plurality of notifications of applications executing within the computing environment; and the second graphics content may include elements that identify respective notifications of the plurality of notifications.

(S9) A system may be configured as described in paragraph (S8), wherein the elements may be selectable to cause output of the applications to which the respective notifications correspond to be presented within a window of the virtual desktop.

The following paragraphs (CRM1) through (CRM9) describe examples of computer-readable media that may be implemented in accordance with the present disclosure.

(CRM1) At least one non-transitory computer-readable medium may be encoded with instructions which, when executed by the at least one processor included in a system, cause the system to receive, by a client device and from a remote computing system via a first communications channel, first graphics content for a virtual desktop of a computing environment hosted on the remote computing system and delivered to the client device, to send, from the client device to at least one external monitor, the first graphics content such that at least a portion of the virtual desktop is presented on the at least one external monitor, to receive, by the client device and from the remote computing system via a second communications channel that is different than the first communications channel, first data indicative of at least one characteristic of plurality of resources hosted in the computing environment and accessible via the virtual desktop, and while the virtual desktop is presented on the at least one external monitor, to present, on a touchscreen of the client device and based at least in part on the first data, second graphics content indicative of the at least one characteristic of the plurality of resources.

(CRM2) At least one non-transitory computer-readable medium may be configured as described in paragraph (CRM1), and may be further encoded with additional instructions which, when executed by the at least one processor, further cause the system to send, from the client device to the remote computing system, second data indicative of a first input provided to a portion of the touchscreen on which the second graphics content is displayed, the portion of the touchscreen corresponding to a first resource of the plurality of resources, and the second data configured to cause a first action to be taken with respect to the first resource.

(CRM3) At least one non-transitory computer-readable medium may be configured as described in paragraph (CRM2), wherein the first action may comprise causing a window corresponding to the first resource to be presented in a foreground of the virtual desktop.

(CRM4) At least one non-transitory computer-readable medium may be configured as described in paragraph (CRM2) or paragraph (CRM3), wherein the first action may comprise launching, within the computing environment, an application corresponding to the first resource.

(CRM5) At least one non-transitory computer-readable medium may be configured as described in any of paragraphs (CRM1) through (CRM4), and may be further encoded with additional instructions which, when executed by the at least one processor, further cause the system to receive, by the client device and from an external user interface device, an indication of a second input to the external user interface device; and to send, from the client device to the remote computing system, third data indicative of the second input, the third data causing a second action to be taken with respect to an application that is represented in a foreground window of the virtual desktop.

(CRM6) At least one non-transitory computer-readable medium may be configured as described in any of paragraphs (CRM1) through (CRM5), wherein the first data may be indicative of a plurality of applications that are installed within the computing environment and accessible via the virtual desktop; and the second graphics content may include elements that identify respective applications of the plurality of applications, the elements being selectable to cause output of the identified applications to be presented within the virtual desktop.

(CRM7) At least one non-transitory computer-readable medium may be configured as described in any of paragraphs (CRM1) through (CRM6), wherein the first data may be indicative of a plurality of files that are accessible to the computing environment; and the second graphics content may include elements that identify respective files of the plurality of files, the elements being selectable to cause content of the identified files to be presented within the virtual desktop.

(CRM8) At least one non-transitory computer-readable medium may be configured as described in any of paragraphs (CRM1) through (CRM7), wherein the first data may be indicative of a plurality of notifications of applications executing within the computing environment; and the second graphics content may include elements that identify respective notifications of the plurality of notifications.

(CRM9) At least one non-transitory computer-readable medium may be configured as described in paragraph (CRM8), wherein the elements may be selectable to cause output of the applications to which the respective notifications correspond to be presented within a window of the virtual desktop.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a client device and from a remote computing system via a first communications channel, first graphics content for a virtual desktop of a computing environment hosted on the remote computing system and delivered to the client device;
sending, from the client device to at least one external monitor, the first graphics content such that at least a portion of the virtual desktop is presented on the at least one external monitor;
receiving, by the client device and from the remote computing system via a second communications channel that is different than the first communications channel, first data indicative of at least one characteristic of plurality of resources hosted in the computing environment and accessible via the virtual desktop; and
while the virtual desktop is presented on the at least one external monitor, presenting, on a touchscreen of the client device and based at least in part on the first data, second graphics content indicative of the at least one characteristic of the plurality of resources.

2. The method of claim 1, further comprising:
sending, from the client device to the remote computing system, second data indicative of a first input provided to a portion of the touchscreen on which the second graphics content is displayed, the portion of the touchscreen corresponding to a first resource of the plurality of resources, and the second data causing a first action to be taken with respect to the first resource.

3. The method of claim 2, wherein the first action comprises causing a window corresponding to the first resource to be presented in a foreground of the virtual desktop.

4. The method of claim 3, wherein the first action further comprises launching, within the computing environment, an application corresponding to the first resource.

5. The method of claim 2, further comprising:
receiving, by the client device and from an external user interface device, an indication of a second input to the external user interface device; and
sending, from the client device to the remote computing system, third data indicative of the second input, the third data causing a second action to be taken with respect to an application that is represented in a foreground window of the virtual desktop.

6. The method of claim 1, wherein:
the first data is indicative of a plurality of applications that are installed within the computing environment and accessible via the virtual desktop; and
the second graphics content includes elements that identify respective applications of the plurality of applications, the elements being selectable to cause output of the identified applications to be presented within the virtual desktop.

7. The method of claim 1, wherein:
the first data is indicative of a plurality of files that are accessible to the computing environment; and
the second graphics content includes elements that identify respective files of the plurality of files, the elements being selectable to cause content of the identified files to be presented within the virtual desktop.

8. The method of claim 1, wherein:
the first data is indicative of a plurality of notifications of applications executing within the computing environment; and
the second graphics content includes elements that identify respective notifications of the plurality of notifications.

9. The method of claim 8, wherein the elements are selectable to cause output of the applications to which the respective notifications correspond to be presented within a window of the virtual desktop.

10. A system, comprising:
at least one processor; and
at least one computer-readable medium encoded with instructions which, when executed by the at least one processor, cause the system to:
receive, by a client device and from a remote computing system via a first communications channel, first graphics content for a virtual desktop of a computing environment hosted on the remote computing system and delivered to the client device,
send, from the client device to at least one external monitor, the first graphics content such that at least a portion of the virtual desktop is presented on the at least one external monitor,
receive, by the client device and from the remote computing system via a second communications channel that is different than the first communications channel, first data indicative of at least one characteristic of plurality of resources hosted in the computing environment and accessible via the virtual desktop, and
while the virtual desktop is presented on the at least one external monitor, present, on a touchscreen of the client device and based at least in part on the first data, second graphics content indicative of the at least one characteristic of the plurality of resources.

11. The system of claim 10, wherein the at least one computer-readable medium is further encoded with additional instructions which, when executed by the at least one processor, further cause the system to:
send, from the client device to the remote computing system, second data indicative of a first input provided to a portion of the touchscreen on which the second graphics content is displayed, the portion of the touchscreen corresponding to a first resource of the plurality of resources, and the second data configured to cause a first action to be taken with respect to the first resource.

12. The system of claim 11, wherein the first action comprises causing a window corresponding to the first resource to be presented in a foreground of the virtual desktop.

13. The system of claim 12, wherein the first action further comprises launching, within the computing environment, an application corresponding to the first resource.

14. The system of claim 11, wherein the at least one computer-readable medium is further encoded with additional instructions which, when executed by the at least one processor, further cause the system to:
receive, by the client device and from an external user interface device, an indication of a second input to the external user interface device; and
send, from the client device to the remote computing system, third data indicative of the second input, the third data configured to cause a second action to be taken with respect to an application that is represented in a foreground window of the virtual desktop.

15. The system of claim 10, wherein:
the first data is indicative of a plurality of applications that are installed within the computing environment and accessible via the virtual desktop; and
the second graphics content includes elements that identify respective applications of the plurality of applications, the elements being selectable to cause output of the identified applications to be presented within the virtual desktop.

16. The system of claim 10, wherein:
the first data is indicative of a plurality of files that are accessible to the computing environment; and
the second graphics content includes elements that identify respective files of the plurality of files, the elements being selectable to cause content of the identified files to be presented within the virtual desktop.

17. The system of claim 10, wherein:
the first data is indicative of a plurality of notifications of applications executing within the computing environment; and
the second graphics content includes elements that identify respective notifications of the plurality of notifications.

18. The system of claim 7, wherein the elements are selectable to cause output of the applications to which the respective notifications correspond to be presented within the virtual desktop.

19. At least one non-transitory computer-readable medium encoded with instructions which, when executed by the at least one processor included in a system, cause the system to:
receive, by a client device and from a remote computing system via a first communications channel, first graphics content for a virtual desktop of a computing environment hosted on the remote computing system and delivered to the client device;
send, from the client device to at least one external monitor, the first graphics content such that at least a portion of the virtual desktop is presented on the at least one external monitor;
receive, by the client device and from the remote computing system via a second communications channel that is different than the first communications channel, first data indicative of at least one characteristic of plurality of resources hosted in the computing environment and accessible via the virtual desktop; and
while the virtual desktop is presented on the at least one external monitor, present, on a touchscreen of the client device and based at least in part on the first data, second graphics content indicative of the at least one characteristic of the plurality of resources.

20. The at least one non-transitory computer-readable medium of claim 19, further encoded with additional instructions which, when executed by the at least one processor, further cause the system to:
send, from the client device to the remote computing system, second data indicative of a first input provided to a portion of the touchscreen on which the second graphics content is displayed, the portion of the touchscreen corresponding to a first resource of the plurality of resources, and the second data configured to cause a first action to be taken with respect to the first resource.
